(19) United States
(12) Patent Application Publication
(10) Pub. No.: US 2026/0180797 A1
(43) Pub. Date: Jun. 25, 2026

(54) ELECTRONIC APPARATUS AND CONTROL METHOD THEREOF

(71) Applicant: CRYPTO LAB INC., Seoul (KR)

(72) Inventors: Jung Hee Cheon, Seoul (KR); Minsik Kang, Seoul (KR); Jai Hyun Park, Lyon (FR)

(21) Appl. No.: 19/222,753

(22) Filed: May 29, 2025

(30) Foreign Application Priority Data
May 31, 2024 (KR) 10-2024-0071750
May 22, 2025 (KR) 10-2025-0066970

(51) Int. Cl. H04L 9/08

(52) U.S. Cl. CPC H04L 9/088

(57) ABSTRACT

An electronic apparatus is disclosed. The electronic apparatus includes a memory storing instructions, a communication interface, and at least one processor configured to include a processing circuitry, in which the at least one processor is configured to generate a transmission key based on a second modulus of an extended ring that is larger than a first modulus of a subring, and controls the communication interface to transmit the transmission key to a server.

### TECHNICAL FIELD

Apparatuses and methods consistent with the present disclosure relate to an electronic apparatus and a control method thereof, and more particularly, to an electronic apparatus providing a transmission key to a server, and a control method thereof.

### BACKGROUND ART

In accordance with the development of an electronic technology, various kinds of electronic apparatuses have been developed. In particular, encryption/decryption technologies for information security are being developed recently with the development of most communication technologies.

When messages encrypted by the encryption technology are delivered to the other party, the other party needs to perform decryption in order to use the messages. In this case, resources and time may be wasted in the process of decrypting encrypted data. In addition, the decrypted message may be hacked while temporarily decrypting the message for computation.

In order to solve this problem, homomorphic encryption is being studied. According to the homomorphic encryption (HE), even if an computation is performed using ciphertexts themselves without decrypting the encrypted information, it is possible to obtain the same result as the encrypted value after an computation on a plain text. That is, according to the homomorphic encryption, the various computations may be performed without decrypting the ciphertext.

However, keys of the homomorphic encryption have a considerable capacity, making it difficult to implement actual applications in small devices. Ring learning with errors (RLWE) ([SSTX09], [LPR10]) is used for high throughput, but RLWE-based homomorphic encryptions ([BGV14], [Bra12], [FV12], [CKKS17]) require evaluation keys that may reach tens of gigabytes, which causes large computational and communication costs and memory overhead for generating, transmitting, and storing the keys.

### DISCLOSURE OF INVENTION

### Solution to Problem

In accordance with an aspect of the disclosure, an electronic apparatus includes: a memory storing instructions; a communication interface; and at least one processor configured to include a processing circuitry, in which the at least one processor is configured to generate a transmission key based on a second modulus of an extended ring that is larger than a first modulus of a subring, and controls the communication interface to transmit the transmission key to a server.

The at least one processor may be configured to generate a plurality of secret polynomials, acquire a combined polynomial of the extended ring based on the plurality of secret polynomials, acquire a plaintext polynomial based on the combined polynomial and a third modulus for key switching, and encrypt the plaintext polynomial on the extended ring to generate the transmission key.

The at least one processor may be configured to generate the transmission key in a form of one ciphertext including a third modulus for key switching based on the second modulus and a second gadget rank of the extended ring that is smaller than a first gadget rank of the subring, and the transmission key may include a value obtained by multiplying a target secret key by a preset coefficient.

The at least one processor may be configured to acquire, as a homing key, a key switching key for a partial polynomial based on the partial polynomial of a secret key of the subring and a target secret key of the extended ring, and control the communication interface to transmit the homing key and the transmission key to the server.

The at least one processor may be configured to generate the homing key by inputting a preset term of the secret key to a special key generation function configured based on gadget decomposition used in key switching.

The homing key may be a key of the subring.

The transmission key may be switched into an computation key of the subring through ring switching based on a homing key by the server, and the transmission key may have a smaller capacity than the computation key.

The transmission key may be switched into an intermediate key by the server based on the second modulus and a second gadget rank of the extended ring that is smaller than a first gadget rank of the subring, and the intermediate key may be switched into a computation key of the subring through the ring switching.

The intermediate key may include at least one coefficient of a value included in a fixed-size gadget vector.

In accordance with another aspect of the disclosure, a control method of an electronic apparatus includes: generating a transmission key based on a second modulus of an extended ring that is larger than a first modulus of a subring, and transmitting the transmission key to a server.

The generating of the transmission key may include: generating a plurality of secret polynomials; acquiring a combined polynomial of the extended ring based on the plurality of secret polynomials; acquiring a plaintext polynomial based on the combined polynomial and a third modulus for key switching; and encrypting the plaintext polynomial on the extended ring to generate the transmission key.

The generating of the transmission key may include: generating the transmission key in a form of one ciphertext including a third modulus for key switching based on the second modulus and a second gadget rank of the extended ring that is smaller than a first gadget rank of the subring, and the transmission key may include a value obtained by multiplying a target secret key by a preset coefficient.

The control method may further include: acquiring, as a homing key, a key switching key for a partial polynomial based on the partial polynomial of a secret key of the subring and a target secret key of the extended ring, in which the transmitting may include transmitting the homing key and the transmission key to the server.

The acquiring may include generating the homing key by inputting a preset term of the secret key to a special key generation function configured based on gadget decomposition used in key switching.

The homing key may be a key of the subring.

The transmission key may be switched into an computation key of the subring by the server through ring switching based on a homing key, and the transmission key may have a smaller capacity than the computation key.

The transmission key may be switched into an intermediate key by the server based on the second modulus and a second gadget rank of the extended ring that is smaller than a first gadget rank of the subring, and the intermediate key may be switched into a computation key of the subring through the ring switching.

The intermediate key may include at least one coefficient of a value included in a fixed-size gadget vector.

### BRIEF DESCRIPTION OF DRAWINGS

FIG. 1 is a diagram for describing a structure of a network system according to an embodiment of the present disclosure.

FIG. 2 is a diagram for describing a structure of a network system according to an embodiment of the present disclosure.

FIG. 3 is a block diagram illustrating components of an electronic apparatus according to an embodiment of the present disclosure.

FIG. 4 is a diagram for schematically describing a capacity of a transmission key according to an embodiment of the present disclosure.

FIGS. 5 to 7 are diagrams for describing a method of generating a transmission key according to an embodiment of the present disclosure.

FIGS. 8 and 9 are diagrams for describing a size of a key, etc., according to an embodiment of the present disclosure.

FIG. 10 is a flowchart for describing a control method of an electronic apparatus according to an embodiment of the present disclosure.

### MODE FOR INVENTION

Hereinafter, the present disclosure will be described in detail with reference to the accompanying drawings.

General terms that are currently widely used were chosen as terms used in embodiments of the present disclosure in consideration of functions in the present disclosure, but may be changed depending on the intention of those skilled in the art or a judicial precedent, the emergence of a new technique, and the like. In addition, in a specific case, terms arbitrarily chosen by an applicant may exist. In this case, the meaning of such terms will be mentioned in detail in a corresponding description portion of the present disclosure. Therefore, the terms used in the present disclosure should be defined on the basis of the meaning of the terms and the contents throughout the present disclosure rather than simple names of the terms.

In the disclosure, an expression “have,” “may have,” “include,” “may include,” or the like, indicates existence of a corresponding feature (for example, a numerical value, a function, an operation, a component such as a part, or the like), and does not exclude existence of an additional feature.

An expression “at least one of A and/or B” is to be understood to represent “A” or “B” or “any one of A and B.”

Expressions “first,” “second,” “1^{st}” or “2^{nd}” or the like, used in the present disclosure may indicate various components regardless of a sequence and/or importance of the components, will be used only in order to distinguish one component from the other components, and do not limit the corresponding components.

Singular expressions are intended to include plural expressions unless the context clearly indicates otherwise. It will be further understood that the terms “comprises” or “have” used in this specification, specify the presence of stated features, steps, operations, components, parts mentioned in this specification, or a combination thereof, but do not preclude the presence or addition of one or more other features, numerals, steps, operations, components, parts, or a combination thereof.

In the disclosure, the term user may refer to a person using an electronic apparatus or an apparatus (for example, an artificial intelligence electronic apparatus) using the electronic apparatus.

Hereinafter, various embodiments of the present disclosure will be described in detail with reference to the accompanying drawings.

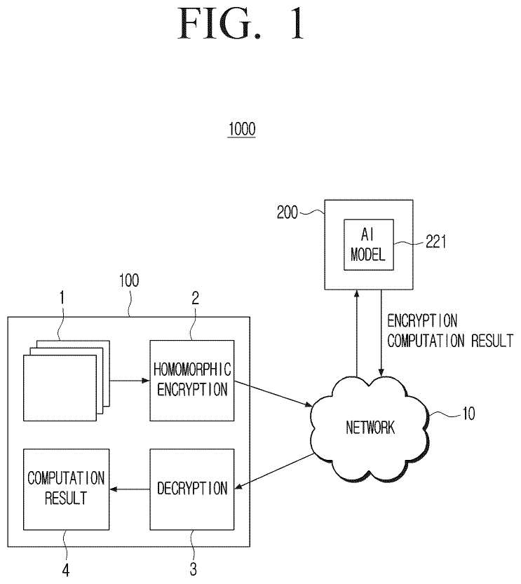

FIG. 1 is a diagram for describing a structure of a network system 1000 according to an embodiment of the present disclosure.

Referring to FIG. 1, an electronic apparatus 100 and a server 200 may communicate with each other through a network 10. The network 10 may be implemented in various types of wired and wireless communication networks, broadcast communication networks, optical communication networks, cloud networks, etc., and each apparatus may be connected in schemes such as Wi-Fi, Bluetooth, near field communication (NFC), etc. without a separate medium.

Although FIG. 1 illustrates one electronic apparatus 100, the electronic apparatus 100 may be implemented in a plurality of different types. For example, the electronic apparatus 100 may be various types of devices such as smartphones, tablets, PCs, laptop PCs, home servers, kiosks, game players, and cameras. In addition, the electronic apparatus 100 may be implemented in the form of a home appliance with IoT functions applied.

For example, when the electronic apparatus 100 is equipped with a camera, the electronic apparatus 100 may directly capture and acquire at least one original data 1. When the camera is not equipped, the electronic apparatus 100 may receive and store the original data 1 from an external apparatus (e.g., a camera, a memory stick, etc.) through various wired or wireless interfaces. In various embodiments of the present disclosure, the original data 1 may be a photographic image, but is not necessarily limited thereto, and may be a graphic image. Alternatively, the original data 1 may be a video content including a plurality of image frames.

The electronic apparatus 100 may perform homomorphic encryption 2 on at least one original data to acquire a homomorphic ciphertext, and then transmit the homomorphic ciphertext to the server 200 via the network 10.

In this case, there is a possibility that the original data 1 may be hacked and leaked to the outside during the transmission process, or may be leaked by an administrator of the server 200. However, when the original data is transmitted in the form of the homomorphic ciphertext, the original data may not be identified even if it is leaked to the outside. Therefore, the security of the user's personal information or physical characteristics may be strengthened.

There may be various homomorphic encryption algorithms that generate homomorphic ciphertext, but various embodiments of the present disclosure describe a case in which homomorphic encryption is performed using a CKKS Scheme or a modified algorithm based on the CKKS scheme.

In order to transmit the original data in the form of the homomorphic ciphertext, the electronic apparatus 100 may perform encoding. In the homomorphic encryption, the encoding may be a task of converting data into a format that can be encrypted. Since the homomorphic encryption is based on a mathematical structure (e.g., polynomial computation), in the case of the original data 1, the homomorphic encryption may be converted into a form that can be processed by the homomorphic encryption algorithm, and then performed.

In the homomorphic encryption, a slot encoding scheme and a coefficient encoding scheme may generally be used.

The slot encoding is a scheme of allocating data to be encrypted to multiple slots and then encoding the data in units of the entire slot. The slot refers to a data unit that may be stored in parallel in the homomorphic ciphertext. When the ciphertext is expressed in a polynomial form, the coefficients or roots of the polynomial may serve as each slot. When one ciphertext is composed of a total of n slots, n values may be encoded or computed simultaneously. In other words, when the slot encoding is performed, parallel computation for the homomorphic ciphertext may be performed. The slot encoding scheme may vary depending on the homomorphic encryption algorithm. The CKKS scheme described above may perform the slot encoding using Fast Fourier Transform (FFT).

The coefficient encoding scheme is a scheme of converting data to be encrypted into a polynomial form and converting the polynomial coefficients into encrypted values. The CKKS scheme described above may perform coefficient encoding using Discrete Fourier Transform (DFT).

The server 200 is an apparatus for performing computation in a homomorphic encrypted state on the homomorphic ciphertext (i.e., at least one homomorphic encrypted original data) provided from the electronic apparatus 100 and providing an encrypted computation result. The server 200 may be implemented in various forms such as a web server and a cloud server.

The server 200 may store an AI model 221 for performing the computation in the encrypted state. As described above, in the case of receiving the original data and performing the computation based on the original data, the AI model 221 may be a convolutional neural network (CNN), but is not necessarily limited thereto.

Specifically, the AI model 221 may perform various computations on the homomorphic ciphertext encrypted with the homomorphic encryption (e.g., CKKS scheme) technology and output the computation result in the form of the homomorphic ciphertext. Hereinafter, the computation result output in the form of the homomorphic ciphertext is called the encryption computation result.

In the case where the AI model 221 is configured as the CNN, the AI model 221 of the server 200 performs depth-specific convolution computation or convolution computation using model parameters on the homomorphic ciphertext transmitted from the electronic apparatus 100. This computation method will be described in detail in the following section.

The server 200 transmits the encrypted computation result to the electronic apparatus 100 via the network 10. The electronic apparatus 100 may decrypt 3 the received encrypted computation result and provide the computation result 4 to the user. The method of providing the result may vary depending on the type and configuration of the electronic apparatus 100.

For example, when the electronic apparatus 100 has a built-in display or is connected to an external display (e.g., a monitor), the decrypted computation result 4 may be displayed.

For example, when the electronic apparatus 100 has a speaker, a voice message corresponding to the computation result may be output through the speaker.

For example, when the electronic apparatus 100 communicates with other terminal devices (e.g., a smartphone, etc.), the decrypted computation result may be transmitted to the terminal device.

For example, when the AI model 221 is a model trained to diagnose the presence or absence of disease, the computation result may include information on the presence or absence of disease, a type of the disease, a progress status of disease, etc., based on the user's original data 1.

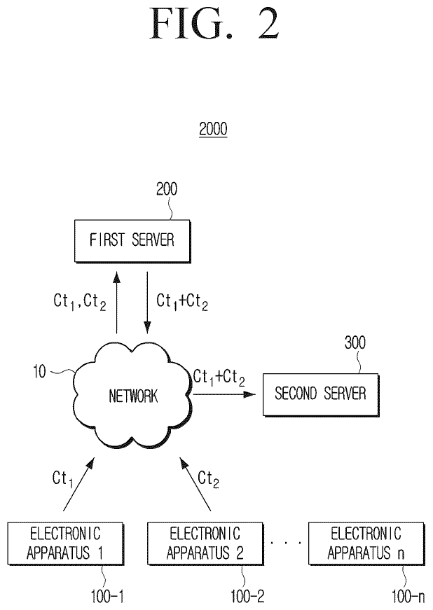

FIG. 2 is a diagram for describing a structure of a network system 2000 according to an embodiment of the present disclosure.

Referring to FIG. 2, a network system may include a plurality of electronic apparatus 100-1 to 100-n, a first server 200, and a second server 300, each of which may be connected to each other through the network 10.

The network 10 may be implemented in various types of wired and wireless communication networks, broadcast communication networks, optical communication networks, cloud networks, etc., and each apparatus may be connected in a scheme such as Wi-Fi, Bluetooth, near field communication (NFC), etc., without a separate medium.

Although FIG. 2 illustrates that the electronic apparatus is the plurality of electronic apparatuses 100-1 to 100-n, the plurality of electronic apparatuses are not necessarily used, and one apparatus may be used. For example, the electronic apparatuses 100-1 to 100-n may be implemented as various types of apparatuses such as smartphones, tablets, game players, PCs, laptop PCs, home servers, and kiosks. In addition, the electronic apparatuses 100-1 to 100-n may be implemented in the form of home appliances to which an IoT function is applied.

Users may input various types of information through the electronic apparatuses 100-1 to 100-n they use. The input information may be stored in the electronic apparatuses 100-1 to 100-n themselves, but may also be transmitted to and stored in an external apparatus for reasons such as storage capacity and security. In FIG. 2, the first server 200 may serve to store such information, and the second server 300 may serve to use some or all of the information stored in the first server 200.

Each of the electronic apparatuses 100-1 to 100-n may perform the homomorphic encryption on the input information and transmit the homomorphic ciphertext to the first server 200.

Each of the electronic apparatuses 100-1 to 100-n may include encryption noise, i.e., an error, generated during the process of performing the homomorphic encryption in the ciphertext. Specifically, the homomorphic ciphertext generated by each of the electronic apparatuses 100-1 to 100-n may be generated in a form in which a result value including a message and an error value is restored when decrypted later using a secret key.

For example, when the homomorphic ciphertext generated by the electronic apparatuses 100-1 to 100-n is decrypted using the secret key, the homomorphic ciphertext may be generated in a form that satisfies the following natures.

$$Dec ( ct , sk ) < ct , sk >= M + e ( mod q ) \qquad [ Equation 1 ]$$

Here, <, > denotes a dot product computation (usual inner product), ct denotes a ciphertext, sk denotes a secret key, M denotes a plaintext message, e denotes an encryption error value, and mod q denotes a modulus of the ciphertext. q should be chosen to be greater than a result value M obtained by multiplying a scaling factor Δ by a message. When an absolute value of the error value e is sufficiently small compared to M, a decryption value M+e of the ciphertext is a value that may replace the original message with the same precision in significant figure computation. Among the decrypted data, an error may be arranged on the least significant bit (LSB) side, and M may be arranged on the next least significant bit side.

When a size of the message is too small or too large, the size may be adjusted using a scaling factor. When the scaling factor is used, not only an integer type message but also a real number type message may be encrypted, and thus, the usability of the message may be greatly increased. In addition, by adjusting the size of the message using the scaling factor, a size of an area where messages exist in the ciphertext after the computation is made, that is, a size of an effective area may also be adjusted.

Depending on the embodiment, a modulus q of the ciphertext may be set and used in various forms. For example, the modulus of the ciphertext may be set in the form of q=Δ^{L} which is an exponent of the scaling factor Δ. When Δ is 2, the modulus may be set to a value such as q=2¹⁰.

In addition, the homomorphic ciphertext according to the present disclosure is described on the assumption that a fixed point is used, but may be applied even when a floating point is used.

The first server 200 may store the received homomorphic ciphertext in the ciphertext state without decrypting the received homomorphic ciphertext.

The second server 300 may request a specific processing result for the homomorphic ciphertext from the first server 200. The first server 200 may perform a specific computation according to the request of the second server 300 and then transmit the result to the second server 300.

For example, when ciphertext ct1 and ct2 transmitted by the two electronic apparatuses 100-1 and 100-2 are stored in the first server 200, the second server 300 may request, from the first server 200, a value obtained by summing the information provided from the two electronic apparatuses 100-1 and 100-2. The first server 200 may perform the computation for summing the two ciphertexts according to the request, and then transmit the result value ct1+ct2 to the second server 300.

Due to the nature of the homomorphic ciphertext, the first server 200 may perform the computation without performing the decryption, and the result value is also in the form of the ciphertext. In the present disclosure, the result value acquired by the computation is referred to as the computation result ciphertext.

The first server 200 may transmit the computation result ciphertext to the second server 300. The second server 300 may decrypt the received computation result ciphertext and acquire the computation result value of the data included in each homomorphic ciphertext.

Thereby, the electronic apparatus 100 may perform efficient multiplication computation while minimizing the number of RNS moduli, thereby enabling faster computation of homomorphic ciphertext.

Meanwhile, FIG. 2 illustrates the case where the first electronic apparatus and the second electronic apparatus perform the encryption and the second server performs the decryption, but is not necessarily limited thereto.

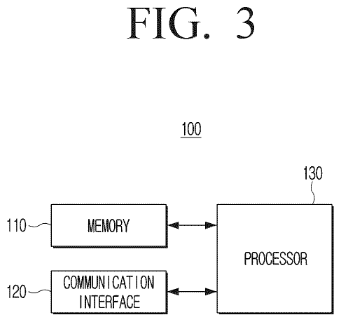

FIG. 3 is a block diagram illustrating components of the electronic apparatus 100 according to an embodiment of the present disclosure.

Referring to FIG. 3, the electronic apparatus 100 includes a memory 110 storing instructions, a communication interface 120, and at least one processor 130. At least one processor 130 may perform the following operations by executing the instructions.

The memory 110 may refer to hardware that stores information such as data in an electrical or magnetic form so that the processor 130 or the like may access the memory 110. To this end, the memory 110 may be implemented as at least one hardware of a non-volatile memory, a volatile memory, a flash memory, a hard disk drive (HDD), a solid state drive (SDD), a RAM, a ROM, or the like.

At least one instruction necessary for the operations of the electronic apparatus 100 or the processor 130 may be stored in the memory 110. Here, the instruction is a code unit instructing the operations of the electronic apparatus 100 or the processor 130, and may be written in machine language, which is a language that a computer may understand. Alternatively, a plurality of instructions that perform a specific task of the electronic apparatus 100 or the processor 130 may be stored in the memory 110 as an instruction set.

The memory 110 may store data that is information in units of bits or bytes capable of representing characters, numbers, images, and the like. For example, data to be encrypted, encrypted data, etc., may be stored in the memory 110.

The memory 110 is accessed by the processor 130, and reading/recording/modifying/deleting/updating, etc. of instructions, instruction sets, or data may be performed by the processor 130.

The communication interface 120 is a component performing communication with various types of external apparatuses depending on various types of communication schemes. For example, the electronic apparatus 100 may communicate with the server 200 through the communication interface 120.

The communication interface 120 may include a wireless fidelity (WiFi) module, a Bluetooth module, an infrared communication module, a wireless communication module, and the like. Here, each communication module may be implemented in the form of at least one hardware chip.

The Wi-Fi module and the Bluetooth module perform communication in a Wi-Fi scheme and a Bluetooth scheme, respectively. In the case of using the Wi-Fi module or the Bluetooth module, various connection information such as a service set identifier (SSID), a session key, and the like, is first transmitted and received, communication is connected using the connection information, and various information may then be transmitted and received. The infrared communication module performs communication according to an infrared data association (IrDA) technology of wirelessly transmitting data to a short distance using an infrared ray positioned between a visible ray and a millimeter wave.

The wireless communication module may include at least one communication chip performing communication according to various wireless communication standards such as zigbee, 3^{rd} generation (3G), 3^{rd} generation partnership project (3GPP), long term evolution (LTE), LTE advanced (LTE-A), 4^{th} generation (4G), 5^{th} generation (5G), and the like, in addition to the communication scheme described above.

Alternatively, the communication interface 120 may include a wired communication interface such as HDMI, DP, Thunderbolt, USB, RGB, D-SUB, and DVI.

In addition, the communication interface 120 may include a local area network (LAN) module, an Ethernet module, and at least one of wired communication modules performing communication using a pair cable, a coaxial cable, an optical fiber cable, or the like.

The processor 130 generally controls an operation of the electronic apparatus 100. Specifically, the processor 130 may be connected to each component of the electronic apparatus 100 to generally control the operation of the electronic apparatus 100. For example, the processor 130 may be connected to components such as the memory 110 and the communication interface 120 to control the operation of the electronic apparatus 100.

One or more processors 130 may include one or more of a central processing unit (CPU), a graphics processing unit (GPU), an accelerated processing unit (APU), a many integrated core (MIC), a neural processing unit (NPU), a hardware accelerator, or a machine learning accelerator. One or more processors 130 may control one or any combination of other components of the electronic apparatus 100 and may perform operations related to communication or data processing. One or more processors 130 may execute one or more programs or instructions stored in the memory 110. For example, one or more processors 130 may perform a method according to one or more embodiments of the present disclosure by executing one or more instructions stored in the memory 110.

When the method according to an embodiment of the present disclosure includes multiple operations, the multiple operations may be performed by one processor or by multiple processors. For example, when a first operation, a second operation, and a third operation are performed by the method according to an embodiment, the first operation, the second operation, and the third operation may all be performed by the first processor, or the first operation and the second operation may be performed by the first processor (e.g., a general-purpose processor) and the third operation may be performed by the second processor (e.g., an AI-dedicated processor).

The one or more processors 130 may be implemented as a single core processor including one core, or may be implemented as one or more multicore processors including multiple cores (e.g., a homogeneous multicore or a heterogeneous multicore). When one or more processors 130 are implemented as a multi-core processor, each of the plurality of cores included in the multi-core processor may include an internal processor memory such as cache memory and on-chip memory, and a common cache shared by the plurality of cores may be included in the multi-core processor. In addition, each of the plurality of cores (or some of the plurality of cores) included in the multi-core processor may independently read and execute a program command for implementing the method according to an embodiment of the present disclosure, or all (or some) of the plurality of cores may be linked to read and execute the program command for implementing the method according to an embodiment of the present disclosure.

When the method according to an embodiment of the present disclosure includes a plurality of operations, the plurality of operations may be performed by one of the plurality of cores included in the multi-core processor, or may be performed by the plurality of cores. For example, when the first operation, the second operation, and the third operation are performed by the method according to an embodiment, the first operation, the second operation, and the third operation may all be performed by a first core included in the multi-core processor, or the first operation and the second operation may be performed by the first core included in the multi-core processor, and the third operation may be performed by a second core included in the multi-core processor.

In the embodiments of the present disclosure, one or more processor 130 may mean a system on chip (SoC) in which one or more processors and other electronic components are integrated, a single core processor, a multi-core processor, or a core included in the single core processor or the multi-core processor. Here, the core may be implemented as CPU, GPU, APU, MIC, NPU, the hardware accelerator, the machine learning accelerator, etc., but the embodiments of the present disclosure are not limited thereto. However, for the convenience of description, the operation of the electronic apparatus 100 will be described below using the processor 130.

The processor 130 may generate a transmission key based on a second modulus of an extended ring that is larger than a first modulus of a subring, and control the communication interface 120 to transmit the transmission key to the server 200.

For example, the processor 130 may generate a plurality of secret polynomials, acquire a combined polynomial of the extended ring based on the plurality of secret polynomials, acquire a plaintext polynomial based on the combined polynomial and a third modulus for key switching, and encrypt the plaintext polynomial on the extended ring to generate the transmission key.

For example, the processor 130 may generate a basic secret key and an auxiliary secret key for an extended structure that are used for the homomorphic encryption, and may acquire a combined polynomial by combining the basic secret key and the auxiliary secret key for the extended structure. Here, the combined polynomial may be defined in the extended ring having a larger degree than the existing subring, and may include information required when the server 200 restores the combined polynomial with an evaluation key. The processor 130 may acquire a plaintext polynomial by multiplying the combined polynomial by a preset integer value (the third modulus). The third modulus may be a modulus for matching an integer multiple structure required when performing the key switching. The processor 130 may encrypt the plaintext polynomial in the extended ring. The encrypted plaintext polynomial may be a single ciphertext, which may be the transmission key. The server 200 may generate a plurality of evaluation keys from a single transmission key, which will be described later.

Alternatively, the processor 130 generates the transmission key in the form of one ciphertext including a third modulus for key switching based on the second modulus and a second gadget rank of an extended ring smaller than a first gadget rank of the subring, and the transmission key may include a value obtained by multiplying a target secret key by a preset coefficient. Here, the gadget rank is a length of a gadget vector used when performing the key switching or the ring switching, and may be the number of terms required for gadget decomposition of the secret key. The second gadget rank has a higher complexity than the first gadget rank, and when the transmission key is generated in the extended ring, the number of decomposition items (gadget rank) required when the key is restored may be reduced, thereby reducing the size of the ciphertext and increasing the key restoration efficiency of the server 200. The transmission key as described above includes a value in the form that a specific coefficient is multiplied by the target secret key, and the server 200 may acquire an intermediate key by extracting or manipulating necessary values from the ciphertext without decryption.

The processor 130 may acquire a key switching key for a partial polynomial as a homing key based on the partial polynomial of the secret key of the subring and the target secret key of the extended ring, and control the communication interface 120 to transmit the homing key and the transmission key to the server 200. Here, the key switching key enables the secret key defined in the extended ring to be switched based on the secret key defined in the subring. The homing key is configured to enable the key switching computation defined in the subring, and as a result, the server 200 may use the ciphertext in the extended ring in the subring based on the homing key.

The processor 130 may input a preset term of a secret key to a special key generation function configured based on the gadget decomposition used in the key switching to generate the homing key. Here, the homing key may be the key of the subring.

The transmission key is switched into the computation key of the subring through the ring switching based on the homing key by the server 200, and the transmission key may have a smaller capacity than the computation key. That is, the transmission key is compressed key information, and includes information on the plurality of evaluation keys in the compressed form and may be a single ciphertext structure. The transmission key is generated in the extended ring, and the server 200 may restore the intermediate key or the evaluation key from the transmission key, so the electronic apparatus 100 only needs to transmit one ciphertext, thereby reducing the communication cost.

The transmission key is switched into the intermediate key by the server 200 based on the second modulus and the second gadget rank of the extended ring, which is smaller than the first gadget rank of the subring, and the intermediate key may be switched into the computation key of the subring through the ring switching. The intermediate key may include at least one coefficient of a value included in the fixed-size gadget vector.

For example, the server 200 may generate multiple intermediate keys through computation by multiplying the transmission key by the gadget vector coefficient and dividing the transmission key by a preset modulus. Since the mathematical structure used herein is defined in the extension ring, the server 200 may generate the intermediate key even with a smaller gadget rank. That is, in the extension ring, even if the depth of the gadget decomposition is reduced (even if the rank is set small), a sufficiently accurate intermediate key may be generated. Although the intermediate key belongs to the extension ring, the intermediate key may be switched into the evaluation key of the subring through the ring switching using the homing key. That is, a multiplication key, a rotation key, a conjugation key, etc., of the subring may be generated from the intermediate key.

As described above, since the electronic apparatus 100 transmits the transmission key to the server 200 and the server 200 may generate a plurality of evaluation keys from the transmission key, the transmission efficiency may be increased compared to the case where the ciphertext was transmitted for each computation key in the past.

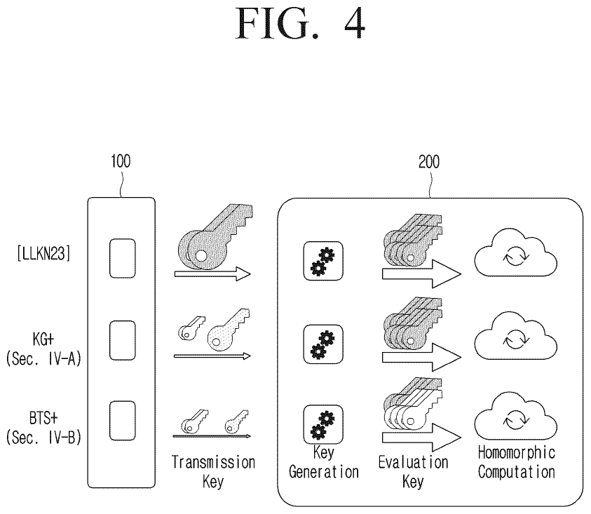

Hereinafter, the operation of the electronic apparatus 100 will be described in more detail through FIGS. 4 to 9. In FIGS. 4 to 9, individual embodiments are described for convenience of description. However, individual embodiments of FIGS. 4 to 9 may be implemented in any combination.

FIG. 4 is a diagram for schematically describing a capacity of a transmission key according to an embodiment of the present disclosure.

A considerable capacity key of a fully homomorphic encryption (FHE) may be a problem for a client (which is the same as the electronic apparatus 100, and the operation of the client may be the operation of the processor 130 below) with limited computational capabilities. For example, Lee-Lee-Kim-No ([LKKN23], [Asiacrypt 2023]) in FIG. 4 proposed a hierarchical key system to partially solve this problem, but a total key size for actual applications is still several gigabytes, which may be burdensome for mobile phones or Internet of Things (IoT) devices.

The present disclosure includes novel key management systems KG+ and BTS+ based on a [LKKN23] system to reduce the FHE cost of the client. The KG+ system may drastically reduce the key size without damaging the efficiency of the homomorphic computation, and the BTS+ system may further reduce the key size by partially compromising granularity of the homomorphic computation. In the [LLKN23], the client should send several large transport keys, while in KG+, the client may transmit several small transport keys with parameters whose sizes are optimized and one large key (homing key). The BTS+ system may further reduce the size of the homing key.

The server 200 may generate homomorphic encryption keys with optimized parameters for computational efficiency from the transport keys. In both the systems, the evaluation keys may be generated from the extension rings. By utilizing the extension ring, a sufficient moduli budget may be secured when generating the keys even when the transmission key is used as an input value. That is, the ring-switching technique ([GHPS13]), which was previously used only for the ciphertext, may be extended to the key. By utilizing the ring-switching technique, the client may transmit the transmission key in the extension ring, and these may be used to generate the FHE key in the subring with high computational efficiency. By separating the rings used for the transmission and computation, the communication cost required for the FHE key transmission may be reduced. In addition, multiple homomorphic encryption (HE) keys may be compressed into a single ciphertext in the extension ring.

The CKKS FHE parameters, which are set to 325 to 609 MB when the client key uses KG+ and 285 MB when the client key uses BTS+, may be used. All the parameters may be generated in a ring degree 2¹⁶, which is generally used in CKKS applications, and may be suitable for privacy-preserving machine learning (PPML). This may be 3.09 to 4.37 times and 3.51 to 9.30 times smaller than the [LKKN23] scheme, respectively. In actual applications, the server 200 requires more evaluation keys for faster homomorphic computation, and for example, KG+ and BTS+ may provide client key sizes of 325 to 609 MB and 285 MB, respectively, under the parameters set for secure inference of ResNet-20, which may be 3.95 to 5.73 times and 4.53 to 12.25 times smaller than the [LKKN23], respectively.

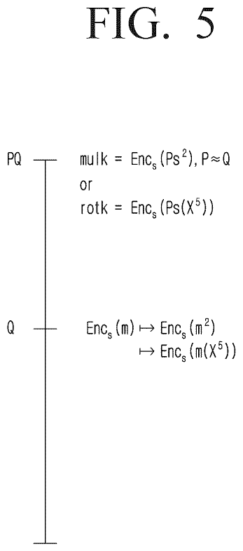

FIGS. 5 to 7 are diagrams for describing a method of generating a transmission key according to an embodiment of the present disclosure.

According to the conventional HE scheme, as illustrated in FIG. 5, the computation key may be located at PQ, which is larger than a modulus Q of the ciphertext. However, since Q is consumed for each multiplication, it is necessary to secure Q sufficiently to improve computing capability.

The RLWE-based HE scheme may have a tightly usable modulus budget when the security level and the ring degree are fixed. To avoid the performance degradation of the homomorphic computation, the hierarchical system for key generation should not consume too much modulus, and accordingly, the size of each master rotation key may be sufficiently large.

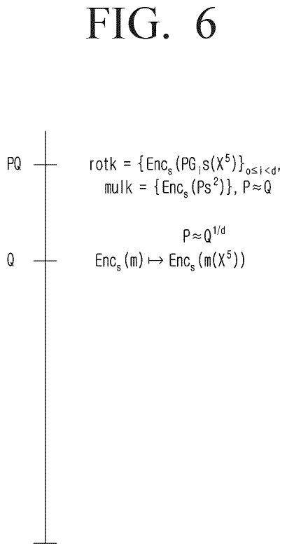

For example, as illustrated in FIG. 6, the modulus PQ of the rotation key may be set close to a specific modulus budget Qmax. At the same time, a modulus PM)PQ of the master rotation key may be smaller than Qmax to maintain the same security level on the same ring, and accordingly, P⁽¹⁾ may be much smaller than PQ. In addition, since the gadget rank of the master rotation key is large, the size of each master rotation key may also be large.

However, even in this case, there is a problem that the key size is too large. For example, 38 rotation keys are required for bootstrapping, 265 rotation keys are required for a ResNet model, and the transmission capacity is very large.

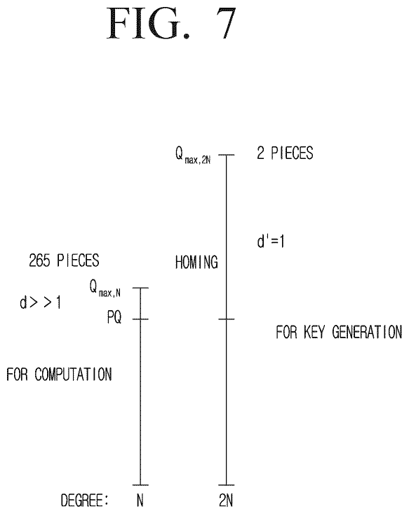

As illustrated in FIG. 7, the present disclosure may use different parameters for the transmission key and the evaluation key. For example, for the transmission key, the extension ring may be used to secure a wider modulus budget and generate a key. Here, the P)PQ is set to be larger than Qmax by increasing the ring degree, and the key size may be reduced by keeping the gadget rank required for the transmission key small. To introduce the extension ring into the key generation, the client generates the intermediate key, and the intermediate key belongs to the extension ring, but may include information about the secret key in the original ring. The client generates intermediate keys based on the given transmission keys, and the server 200 switches the ring, which is the basis of the intermediate keys, to generate the evaluation key in the subring To explain this, three core technologies are first described.

### 1. Ring Switching for HE Keys

Conventionally, the ring switching technology has been applied to the ciphertext, but not to keys. The present disclosure extends the ring switching technique ([BGV14], [GHPS13]) to be applied to the HE key. For example, the ring that is the basis of the HE key may be switched from R′ to R. The HE key is a tuple of the ciphertexts, which may be written as follows.

$${\{ {Enc}_{s} ( {PG}_{i} \cdot {s}^{′} ) \}}_{i = 0 , … , {d}_{num} - 1}$$

Here, P and Gᵢ are constants, and Enc may be an encryption function. For each Encₛ(PGᵢ·s′) the underlying ring of the corresponding key may be switched by applying the ring switching. That is, a ciphertext Encₛ˜(PGᵢ·s′) based on a secret key \tilde{s} may be obtained on another ring R. The ring switching applied to the key requires a separate ring-switching key, and the separate ring-switching key is described as the homing key in the following.

### 2. Rotation Key Generation Over Extension Ring

Given a ring R and its extension ring R′, each rotation key rotkᵣ in R may be associated with the ciphertext of the following form.

$${Enc}_{s} ( s ( {X}^{5 r} ) )$$

Here, s is the secret key in the ring R. In the extension ring R′, the corresponding intermediate key Encₛ(s(X^{5r})) is considered, where s′ may be a secret key belonging to R′.

Multiple intermediate keys may be generated in R′ using one ciphertext Encₛ(s(X)) and master rotation keys in a higher modulus. For example, Encₛ(s(X^{5r})) may be generated from Encₛ(s(X)) by r key switching computations, where Encₛ(s′(X⁵)) may be used. This may be a new hierarchical key system based on the extension ring. This may be a scheme of generating intermediate rotation keys from master rotation keys in the extension ring. The hierarchical key system of the present disclosure may also adopt a multilevel scheme as in [LLKN23]. After generating all the intermediate rotation keys, the ring switching technique may be applied to acquire a final rotation key in R.

### 3. General Switching Key Generation Over the Extension Ring

The hierarchical key system of [LLKN23] did not consider the problem of reducing the HE key in a general form other than the rotation key. However, in practice, it is often necessary to transmit various evaluation keys together, such as the multiplication key, the conjugation key, and the general key-switching key. The present disclosure may reduce this general form of the HE key by using the ring switching technique by taking advantage of the fact that the HE key is a tuple of the ciphertext. For example, the present disclosure may take advantage of the fact that the HE key may be multiplied by a constant. Since the extension ring R′ provides a larger modulus budget, the constant multiplication of the HE key may be possible with high precision.

The key switching key from secret key s₀ to s₁ in the ring R may have the following form.

$${swk}_{s 0 \to s 1} = {\{ {Enc}_{{s}_{1}} ( {PG}_{i} \cdot {s}_{0} ) \}}_{i = 0}^{{d}_{num} - 1}$$

Considering the intermediate key in R′, it is as follows.

$${IntSwk}_{s 0 \to {s}^{′}} = {\{ {Enc}_{{s}^{′}} ( {PG}_{i} \cdot {s}_{0} ) \}}_{i = 0}^{{d}_{num} - 1}$$

Here, s′ is the secret key in the R′, and it is assumed that it has the following transmission key.

$${Enc}_{{s}^{′}} ( {PP}^{′} \cdot {s}_{0} )$$

Here, P′ is a special modulus, and P′≈Gᵢ may be for all i.

Multiplying the ciphertext by Gᵢ/P′ may generate the intermediate key. Finally, an intermediate key IntSwk may be switched into actual switching key swk by the ring switching technique, thereby completing the key generation. swk_{s0→s1} Compared to swk_{s0→s1}, Encₛ(PP′·s₀) may be relatively small as long as the gadget rank dₙᵤₘ is not too small.

Hereinafter, prior knowledge to help understanding the present disclosure will be described.

For an integer N greater than or equal to 2 that is a power of 2, a polynomial ring R_{N} is defined as R_{N}=Z[X]/(X^{N}+1), and the residual ring for an integer Q may be represented as R_{N,Q}=R_{N}/QR_{N}. When the ring degree N is fixed, R_{N} may be simply represented as R, and R′=R_{2N}=Z[Y]/(Y^{2N}+1). Here, R may be an appropriate subring of R′ through an embedding map X→Y².

Sampling according to a distribution D is denoted as x←D. For the ring degree N, χₕ with coefficients uniformly distributed over R in {−1,0,1} and exactly h non-trivial coefficients, and χ_{σ} with coefficients independently sampled from a discrete Gaussian distribution with variance σ² are defined. For an integer n, the set of non-negative integers less than n is denoted as [n]={0,1, . . . , n-1}. The ciphertext for a plaintext m∈R based on RLWE is a pair of

$$( b , a ) ∈ {R}_{Q}^{2}$$

that satisfies the following condition:

$$b = - a \cdot s + m + e ( mod Q )$$

where s←χₕ is the secret key, Q is the ciphertext modulus, and a←R_{Q}, e←χ_{σ} may be errors.

### A. RNS-based Gadget Decomposition and Key Switching

The ciphertext modulus

$$Q = {\prod }_{{}_{i = 1} {q}_{i}}^{l - 1}$$

is the product of coprime numbers q₀, . . . , qₜ₋₁. Here, the RNS-based gadget decomposition of rank dₙᵤₘ will be described. For 0≤I<dₙᵤₘ, α=[ϑ/dₙᵤₘ],

$${Q}_{i} = {\prod }_{j = i α}^{( i + 1 ) α - 1} {q}_{i}$$

is set. The RNS-based gadget decomposition proposed in [HK20] is defined as RQ→R^{dnum}, which may map α to

$$( {[ {\hat{Q}}_{0}^{- 1} \cdot a ]}_{{Q}_{0}} , … , ( {[ {\hat{Q}}_{dnum - 1}^{- 1} \cdot a ]}_{{Q}_{dnum - 1}} ) .$$

Here, \hat{Q}ᵢ=Q/Qᵢ. If

$$G = ( {G}_{0} , … , {G}_{dnum - 1} ) ( {\hat{Q}}_{0} , … , {\hat{Q}}_{dnum - 1} ) ∈ {R}_{Q}^{dnum} ,$$

then the following may be established.

$$< h ( a ) , G > = {\sum }_{i = 0}^{dnum - 1} {[ a \cdot {\hat{Q}}_{i}^{- 1} ]}_{{Q}_{i}} \cdot {\hat{Q}}_{i} = a ( mod Q ) .$$

This gadget decomposition is useful for the key switching computations in the RNS-CKKS scheme, and may be used with a special modulus P.

SwkGen(N, Q, QP, s′, s): For secret keys s,s′∈R_{N}, generates the key switching key such as

$$swk = {\{ ( {β}_{i} , {α}_{i} ) \}}_{i ∈ ⌈ dnum ⌉} ∈ {R}_{N , QP}^{2 \times dnum} ,$$

and for each i, the following may be satisfied.

$${β}_{i} = - {α}_{i} \cdot s + {PG}_{i} \cdot {s}^{′} + {e}_{i} ( mod QP ) ,$$

Here, αᵢ←R_{N, QP}, eᵢ←χN_{σ}, and it may be expressed as (βᵢ,αᵢ)=Encₛ(PGᵢ·s′).

KeySwitch_{swk}(ct): The following results are output for the key switching key

$$swk = ( s w {k}_{0} , s w {k}_{1} ) ∈ {R}_{N , Q}^{2 \times dnum} and ct = ( b , a ) ∈ {R}_{N , Q}^{2} .$$

$$( b + ⌈ \frac{< h ( a ) , {swk}_{0} >}{P} ⌋ , ⌈ \frac{< h ( a ) , {swk}_{1} >}{P} ⌋ ) ∈ {R}_{N , Q}^{2}$$

The validity of the key switching computation may be ensured by choosing P satisfying P≥maxᵢQᵢ. If prime numbers q₀, q₁, . . . , qₜ of the same size are used, it is sufficient to choose only one P satisfying P≥Q^{1/dnum}.

The key switching key may be used to perform the homomorphic computation such as rotation, conjugate, and multiplication, which may be defined as follows.

$$mulk ← SwkGen ( N , Q , Q P , {s}^{2} , s ) ,$$

$${rotk}_{r} ← SwkGen ( N , Q , Q P , s ( {X}^{{5}^{r}} ) , s ) ,$$

$$c jk ← SwkGen ( N , Q , Q P , s ( {X}^{- 1} ) , s ) .$$

Using these keys, the following homomorphic computation may be performed.

Mult(ct₁, ct₂):

For ciphertext

$$c {t}_{i} = ( {b}_{i} , {a}_{i} ) ∈ {R}_{Q}^{2} ( i = 0 , 1 ) , ( {d}_{0} , {d}_{1} , {d}_{2} ) = ( {b}_{1} \cdot {b}_{2} , {a}_{1} \cdot {b}_{2} + {a}_{2} \cdot {b}_{1} , {a}_{1} \cdot {a}_{2} )$$

is calculated.

The multiplication result ciphertext is as follows.

$${ct}_{mult} = ( {d}_{0} , {d}_{1} ) + {KeySwitch}_{μ lk} ( 0 , {d}_{2} ) .$$

### Rot(ct, r):

$$For ct = ( b , a ) ∈ {R}_{Q}^{2} , {ct}_{rot , r} ∈ {R}_{Q}^{2}$$

may be output as follows.

$${ct}_{rot , r} = ( b ( {X}^{{5}^{r}} ) , 0 ) + {KeySwitch}_{{rotk}_{r}} ( 0 , a ( {X}^{{5}^{r}} ) ) .$$

In particular, for component-wise rotation, Rot({ctᵢ}_{i∈ϑr}) {Rot(ctᵢ, r)}

### Conj(ct):

For ciphertext

$$ct = ( b , a ) ∈ {R}_{Q}^{2} , c {t}_{con} ∈ {R}_{Q}^{2}$$

may be output as follows.

$$c {t}_{conj} = ( b ( {X}^{- 1} ) , 0 ) + {KeySwitch}_{cjk} ( 0 , a ( {X}^{- 1} ) ) .$$

### B. Ring-switching Technique

The ring-switching technique is proposed in [BGV14], [GHPS13], and may be a method of transforming an underlying ring of a homomorphic ciphertext. That is, this technique may be a way to acquire a ciphertext composed of a secret key of a small ring in R⊂R′ by applying the key switching computation to the ciphertext on R′. According to [BCK+23], the ring switching computation may be performed on a ciphertext in coefficient-encoded form without consuming the modulus.

When the coefficient-based ciphertext

$$c t = E n {c}_{{s}^{′}} ( m ) ∈ {R}_{Q}^{{′}^{2}}$$

is given, the secret key may be switched into a natural embedded secret key s existing in R of R′. As a result, the ciphertext

$$( b , a ) ∈ {R}_{Q}^{{′}^{2}}$$

is obtained, which satisfies the following.

$$b ( Y ) = - a ( Y ) \cdot s ( {Y}^{2} ) + m ( Y ) .$$

When odd terms of (b,a) are extracted, it becomes a ciphertext within

$${R}_{Q}^{2}$$

under the secret key s, and the corresponding ciphertext decrypts the odd terms of m. Similarly, when even terms are extracted, it becomes a ciphertext that decrypts even terms of m within

$${R}_{Q}^{2} .$$

This process switches the underlying ring of the ciphertext from R′ to R, which is called the ring-switching technique.

### C. CKKS Parameters and Key Size

The security of the RLWE may vary depending on the maximum modulus, the ring degree, and the distribution of errors and secret keys. All secret keys and error terms may be sampled from χₕ with fixed hamming weight h and χₑ with variance σ=3.19, respectively. Under this distribution, logQ_{max,N} is assumed to be the bit size of the maximum modulus to ensure a security level of 128 bits. Table 1 cited from [BMTPH21] illustrates logQ_{max,N} according to the combination of N and h. From this, it may be seen that the ratio N/logQₘₐₓ should be roughly constant to maintain the same security level.

TABLE 1

logQₘₐₓ

| h | logQₘₐₓ(N), λ = 128 | N = 2¹⁵ | N = 2¹⁶ |
|---|---|---|---|
| 64 | 0.015121 · N − 8.248756 | 496 | 982 |
| 96 | 0.018896 · N − 3.671642 | 619 | 1234 |
| 128 | 0.021370 · N − 3.601990 | 699 | 1396 |
| 192 | 0.023448 · N − 3.611940 | 767 | 1533 |
| N/2 | [CP19] criterion | 881 | 1782 |

Relationship between modulus bit size logQₘₐₓ and ring degree N according to various Hamming weights h of secret key s

Assume Q_{key} as the modulus of the key switching key and Qₜₒₚ as the top modulus used in the ciphertext calculation. For the security, Q_{key}<Qₘₐₓ, and for the key switching accuracy, Qₜₒₚ<Q_{key}. A larger Q_{key} may provide a higher computational capacity. For the special modulus P, Qₜₒₚ=Q_{key}/P. To control the error growth during the key switching, P should be at least

$${Q}_{top}^{1 / dnum} ,$$

and dₙᵤₘ may be a gadget rank. When Qₘₐₓ=Q_{key} is fixed, in order to use a larger Qₜₒₚ, a larger dₙᵤₘ should be chosen.

In the FHE, the ciphertext modulus may be restored to Q_{comp} through the bootstrapping process. In this case, since the bootstrapping consumes some modulus, Q_{refresh}<Qₜₒₚ. The modulus immediately after the bootstrapping may be called Q_{comp}.

For example, assume that the ciphertext with the modulus Q and the ring degree N is manipulated. The switching key swk belongs to Q_{key}=PQ, where P may be the special modulus for the key switching. Here,

$$P \approx {Q}^{1 / dnum} .$$

The key swk is composed of dₙᵤₘ ciphertexts, and {Encₛ(P\hat{Q}ᵢ·s′)}_{i∈[dnum]}, where G is a gadget vector.
Transmitting this Key Incurs the Following Cost:

$$dnum \cdot N \cdot log ( PQ ) \approx ( dnum + 1 ) \cdot N \cdot log Q .$$

In particular, the client does not need to transmit a random value ‘a’ part. This is because it may be generated as an output of an extended output format function (XOF) using a public seed and counter.

This observation suggests that using a smaller dₙᵤₘ value instead of a larger ring degree may be one option when focusing on the key size. However, this may reduce the granularity of the homomorphic computation.

### D. Hierarchical Rotation Key System

In a hierarchical rotation key system to reduce the transmission cost, the client transmits only a small number of master rotation keys instead of transmitting all the individual rotation keys, and the server may generate the necessary rotation keys from the master rotation keys.

The gist is that the HE key may be a tuple of ciphertexts, which may be switched using the evaluation key with higher modulus. The master rotation key is a rotation key defined in higher modulus. For example, if it is assumed that the number of master rotation keys of r-shift in the modulus P⁽¹⁾PQ is one, and there is the existing rotation key with index r′ in the PQ, another rotation key corresponding to (r+r′)-shift in the modulus PQ may be generated as follows.

$$\begin{matrix}Rot ( {rotk}_{{r}^{′}} , r ) = Rot ( {\{ {Enc}_{s} ( {PG}_{i} \cdot s ( {X}^{{5}^{{r}^{′}}} ) ) \}}_{i ∈ [ dnum ]} , r ) \\ = {\{ {Enc}_{s} ( {PG}_{i} \cdot s ( {( {X}^{{5}^{{r}^{′}}} )}^{{5}^{r}} ) ) \}}_{i ∈ [ dnum ]} \\ = {rotk}_{r + {r}^{′}} .\end{matrix}$$

The rotation key index 0 may be generated from the public key pk=(b, a)=Encₛ(0) as follows.

$$\begin{matrix}{{rotk}_{0} = \{ ( b , a ) + {PG}_{i} ) \}}_{i = ⌈ dnum ⌉} \\ = {\{ {Enc}_{s} ( {PG}_{i} \cdot s ( X ) ) \}}_{i ∈ ⌈ dnum ⌉} .\end{matrix}$$

Combining these two ideas, the client may transmit only a small number of master rotation keys (e.g., 8), and the server 200 may generate a large number of required rotation keys (e.g., 265 or more). For example, given the public key and a master rotation key for 1-shift, any rotation key rotₖ may be generated by repeatedly applying Rot(·,1) from r times up to rotk₀.

[LLKN23] extended this claim to a multi-level hierarchical system. The generated rotation key may be used as the master rotation key to generate another rotation key in a lower modulus. This approach may introduce multiple special primes P=P⁽⁰⁾, P⁽¹⁾, . . . , P^{(k-1)} instead of one within the modulus budget Q_{max,N} for a fixed ring degree N. This may define the modulus of the 1-level in the chain as [symbol] = [symbol] [symbol] , and form a k-level hierarchy Q=Q⁽⁰⁾< . . . <Q^{(k)}≤Q_{max,N}.

In this case, the r-shift rotation key of f-level is defined as follows.

$$r o t {k}_{r}^{( ℓ )} ← SwkGen ( N , {Q}^{( ℓ )} , {Q}^{( ℓ )} {P}^{( ℓ )} , s ( {X}^{{5}^{r}} ) , s ( X ) ) ,$$

The key has the following format.

$$r o t {k}_{r}^{( ℓ )} = {\{ E n {c}_{s} ( {P}^{( ℓ )} {G}_{i}^{( ℓ )} \cdot s ( {X}^{{5}^{r}} ) ) \}}_{i ∈ ⌈ {dnum}^{( ℓ )} ⌉} ,$$

Here,

$${G}_{i}^{( ℓ )}$$

and dₙᵤₘ ( [symbol] ) may be the i-th gadget coefficient and decomposition rank for Q(ϑ), respectively. The k-level hierarchical rotation key system is defined as a chain of (master) rotation keys.

$${\{ r o t {k}_{r}^{( 0 )} \}}_{{T}_{n}} ← {\{ rot {k}_{r}^{( 1 )} \}}_{{T}_{i}} ← … ← {\{ r o t {k}_{r}^{( k - 1 )} \}}_{{T}_{k - 1}} .$$

Here, Tₜ is a set of rotation indices of a ϑ-th level. In particular, Tₖ₋₁ may be a set of master keys transmitted by a client, and T₀ may be a set of target keys required by the server 200. By choosing T₀⊃T₁⊃ . . . ⊃Tₖ₋₁, the entire target key may be composed with only a small number of master keys.

Under the fixed modulus budget, the level of the hierarchical system may provide a trade-off between key generation efficiency and the ability of homomorphic computation on the generated keys. A deeper hierarchy (larger k) allows for a more efficient key system because it reduces the number of keys to be transmitted, but may require a larger [symbol] ᵢP⁽ⁱ⁾. For most PPML applications, k=2 may be an appropriate choice.

In a 2-level setting, [LLKN23] may transmit m master rotation keys (i.e., 1-level key) having indices belonging to an index set {1, p, p², . . . , p^{m-1}}. Here, p is a power of 2 integer closest to n^{1/m}, and n is the number of slots. Then, all target 0-level key indices may be generated from a 1-level key through approximately m·p key rotations.

Based on the above prior knowledge, the operation of the present disclosure is described below.

Key Generation over Extension Ring

First, the transmission key is a key that the client transmits to the server 200. It determines the communication cost, and the secret key is required to generate the transmission key. The evaluation key is a key used for the homomorphic computation. It is an output of the key generation step, and is a key that generally appears when performing the computation. The intermediate key is a key that appears in the key generation step. In general, each intermediate key may correspond to one evaluation key.

Assume the transmission key and the intermediate key belong to the extension ring R′, and the evaluation key belongs to the subring R. In [LLKN23], the master rotation key plays the role of the transmission key, but in the present disclosure, the transmission key and the evaluation key may use the same ring.

A technical tool for generating the evaluation key from the transmission key in the extension ring R′ is described. The key generation on the extension ring R′ is that the intermediate keys on R′ are generated from the transmission key, and the evaluation key on R may be generated from the corresponding intermediate keys.

In particular, the intermediate key-switching from s₀(Y²) to \tilde{s}(Y) on R′ may be considered to generate the key-switching key from s₀(X) to s₁(X).

### A. Ring-Switching for HE Keys

A ring-switching technique for the HE keys may be a method of changing the underlying ring of the key. This may be an extension of the ring-switching technique introduced for HE ciphertext in [BGV14] and [GHPS13].

### 1) Review of Ring-Switching for HE Ciphertext

To introduce a new ring-switching technique for the HE key, the ring-switching techniques for HE ciphertext [BGV14], [GHPS13], and [BCK+23] will be first described.

Assume there is an RLWE-based ciphertext of

$${R}_{Q}^{{′}^{2}}$$

of the plaintext m′, and its secret key s′(Y) may be R′. The secret key may be switched from s′ to s∈R using a switching key Enc_{s(Y}_{^{c}}₎(s′(Y)). Then, the ciphertext

$$( b , a ) ∈ {R}_{Q}^{{′}^{2}}$$

under the secret key s may be acquired. If it is assumed that f(Y)=f₀(X)+Y·f₁(X) in f=a(Y), b(Y), m(Y), f₀ and f₁ belong to R_{Q}, and m₀+Ym₁=m≈as+b=(a₀s+b₀)+Y(a₁s+b₁) As a result, two ciphertext (b0, a0), (b1, a1)∈

$${R}_{Q}^{2} ,$$

which are m₀ and m₁, respectively, may be acquired when decrypted under the secret key s E R. This entire procedure may switch the ring of ciphertext from R′ to R.

### 2) Extending Ring-Switching for HE Keys

The existing technique may be modified so that the ring-switching technique may be applied to the HE keys rather than the HE ciphertext. Technically, the HE key may be considered as a tuple of the HE ciphertexts, and then the ring-switching technique may be applied to each element of the tuple. For s′, the switching key s̅∈R of s̅ from s′ may be of the following form.

$${\{ {Enc}_{{s}^{′}} ( {PG}_{i} \cdot \tilde{s} ) \}}_{i ∈ ⌈ dnum ⌉} ∈ {R}_{P Q}^{2 \times dnum}$$

Here, Q may be the ciphertext modulus, P may be the special modulus for the key switching, and dₙᵤₘ may be the gadget rank. By using the ring switching from s′ to s∈R for each ciphertext Encₛ(PGᵢ·\tilde{s}) the following may be acquired.

$${\{ E n {c}_{s} ( P {G}_{i} \cdot {\tilde{s}}_{0} ) \}}_{i ∈ ⌈ dnum ⌉} and {\{ {Enc}_{s} ( P {G}_{i} \cdot {\tilde{s}}_{1} ) \}}_{i ∈ ⌈ dnum ⌉} ,$$

Here, \tilde{s}(Y)=\tilde{s}₀(X)+Y·\tilde{s}₁(X) and this procedure may generate two switching keys from s to \tilde{s}ᵢ while i=0,1. The ring switching keys for the keys are called the homing keys.

### Theorem 1 (Ring Switching for HE Keys)

If s∈R and \tilde{s}∈R′ are secret keys, \tilde{s} for \tilde{s}₀, s₁∈R may be assumed as \tilde{s}(Y)=\tilde{s}₀(X)+\tilde{s}₁(X). The homing keys hk₀ and hk₁ are as follows for each j=0,1.

$${hk}_{j} ← SwkGen ( N , PQ , {Q}_{m ax , N} , {\tilde{s}}_{j} , s ) ,$$

For s′₀, s′₁∈R assuming the key switching key

$$= {\{ E n {c}_{s} ∼ ( P {G}_{i} \cdot ( {s}_{0}^{′} + {Ys}_{1}^{′} ) ) \}}_{i ∈ ⌈ dnum ⌉} ∈ {R}_{PQ}^{{′}^{2 \times dnum}} ,$$

two evaluation keys evkᵢ may be generated (i=0,1). Each key is a key that switches from s′ to s, and this process requires performing 4×dₙᵤₘ key switching computations in R.

### Proof

The ciphertext (b(Y), a(Y)=Encₛ˜PGᵢ·(s′₀+Y s′₁)) in swk may satisfy the following.

$$b ( Y ) + a ( Y ) \tilde{s} ( Y ) = P {G}_{i} \cdot ( {s}_{0}^{′} + {Ys}_{1}^{′} ) + e ( Y ) mod PQ .$$

In the above equation, for some elements b₀, b₁, a₀, a₁, e₀, e₁ ∈R_{Q}, if b(Y)b₀+Yb₁, a(Y)a₀+Ya₁, e(Y)e₀+Ye₁ then since X=Y², the following may be acquired.

$$( {b}_{0} + {a}_{0} {\tilde{s}}_{0} + ( X {a}_{1} ) {\tilde{s}}_{1} ) + Y \cdot ( {b}_{1} + {a}_{1} {\tilde{s}}_{0} + {a}_{0} {\tilde{s}}_{1} ) = ( P {G}_{i} \cdot {s}_{0}^{′} + {e}_{0} ) + Y \cdot ( {PG}_{i} \cdot {s}_{1}^{′} + {e}_{1} ) ( mod PQ ) ,$$

The secret key s₁ may switch to s using the switching key hkⱼ, and through this, the following may be acquired.

$$E n {c}_{s} ( P {G}_{i} \cdot {s}_{0}^{′} ) ← ( {b}_{0} , 0 ) + {KeySwitch}_{h {k}_{0}} ( 0 , {a}_{0} ) + {KeySwitch}_{h {k}_{1}} ( 0 , X {a}_{1} )$$

$$En {c}_{s} ( P {G}_{i} \cdot {s}_{1}^{′} ) ← ( {b}_{1} , 0 ) + {KeySwitch}_{h {k}_{0}} ( 0 , {a}_{1} ) + KeySwitc {h}_{h {k}_{1}} ( {a}_{0} , 0 ) .$$

When the procedure is performed on all i∈dₙᵤₘ, two key switching keys swk₀ and swk₁ may be acquired.

### Choice of Secret Key

In Theorem 1, two homing keys and two KeySwitches are required for one ring switching. In order to improve the efficiency of the ring switching, the secret key s′ of R′ associated with the secret key s of R may be chosen as follows.

The secret key \tilde{s}=\tilde{s}₀+Y·\tilde{s}₁ of R′ is set to be \tilde{s}₀, \tilde{s}₁∈R. Then, when \tilde{s}₀=s, Theorem 1 may be simplified as follows.

$$E n {c}_{s} ( P {G}_{i} \cdot {s}_{0}^{′} ) ← ( {b}_{0} , {a}_{0} ) + {KeySwitch}_{h k} ( 0 , X {a}_{1} ) ,$$

$$En {c}_{s} ( P {G}_{i} \cdot {s}_{1}^{′} ) ← ( {b}_{1} , {a}_{1} ) + {KeySwitch}_{h k} ( 0 , {a}_{0} ) ,$$

Here, hk←SwkGen(N, PQ, Qₘₐₓ, N, \tilde{s}₁, s), may be one homing key.

### Corollary 2.

From Theorem 1, if it is assumed that the secret key \tilde{s} satisfies \tilde{s}(Y)=s+Y \tilde{s}₁, then the homing key hk is as follows.

$$h k ← SwkGen ( N , P Q , {Q}_{m ax , N} , {\tilde{s}}_{1} , s ) ,$$

With one homing key hk, two evaluation keys evk0 and evk1 may be generated through (2×dₙᵤₘ) key switching computations on R.

### B. Key-Switching Key Generation Over Extension Ring

A method of compressing two switching keys on R into one intermediate key on R′ will be described. Assume that the following key-switching key pairs for j=0,1 on R_{PQ} are given.

$$s w {k}_{{s}_{j} \to s} = {\{ E n {c}_{s} ( P {G}_{i} \cdot {s}_{j} ) \}}_{i = [ dnum ]} ,$$

The intermediate key IntSwk on R′_{PQ} is defined as follows.

$$IntSwk = {\{ E n {c}_{s} ∼ ( P {G}_{i} \cdot ( {s}_{0} + Y \cdot {s}_{1} ) ) \}}_{i = ⌈ dnum ⌉} ,$$

This may switch to the original switching keys swkₛ_{₀}_{→s} and swkₛ_{₁}_{→s}. Now, for another special modulus P′, the following transmission key may be considered.

$$TrmKey = {Enc}_{s} ∼ ( {PP}^{′} \cdot ( {s}_{0} + Y \cdot {s}_{1} ) ) ∈ {R}_{{P}^{′} PQ}^{{′}^{2}}$$

TrmKey may be viewed as a single ciphertext, and may be multiplied by an appropriate constant. For example, if P′ is set large enough to be equal to each gadget coefficient Gᵢ, then each constant Gᵢ/P′ is small, so that the intermediate key IntSwk may be acquired by multiplying TrmKey by Gᵢ/P′. Theorem 3 describes the correctness of this method in detail.

### Theorem 3 (Intermediate Key-Switching Key Generation)

Suppose that swk={Encₛ˜(PGᵢ·\tilde{s}′)}_{i∈[dnum]} is defined on

$${R}_{PQ}^{′ 2 \times dnum} .$$

If an auxiliary modulus P′≥maxᵢGᵢ is chosen, the switching key may be generated from one ciphertext

$${Enc}_{s} ∼ ( {P}^{′} P \cdot \tilde{{s}^{′}} ) ∈ {R}_{{P}^{′} PQ}^{′ 2} .$$

### Proof

Given a ciphertext (b,a)=Encₛ˜(P′P·\tilde{s}′) on R′²_{P′PQ}, the following may be established.

$$b + a \tilde{s} = {P}^{′} P \cdot \tilde{{s}^{′}} + e ( mod {P}^{′} PQ )$$

Multiplying both sides by the coefficient Gᵢ may acquire the following.

$${G}_{i} b + {G}_{i} a \cdot \tilde{s} = {P}^{′} {PG}_{i} \cdot \tilde{{s}^{′}} + {G}_{i} e ( mod {P}^{′} PQ )$$

Rescaling (Gᵢb, Gᵢa) by P′ may acquire the following.

$$\frac{{G}_{i} b + {δ}_{i , 0}}{{P}^{′}} + \frac{{G}_{i} a + {δ}_{i , 1}}{{P}^{′}} \cdot \tilde{s} = {PG}_{i} \cdot \tilde{{s}^{′}} + \frac{{G}_{i} {e}_{i}}{{P}^{′}} + {e}_{rs} ( mod PQ ) ,$$

Here, eᵣₛ=(δ_{i,0}+δ_{i,1}·\tilde{s})/P′ and δ_{i,0}/P′,δ_{i,1}/P′ may be a polynomial with small coefficients. When the error term Gᵢ·e/P′+eᵣₛ is sufficiently small, the rotation key on R′²_{PQ} may be acquired for each i through the following.

$${Enc}_{s} ∼ ( {PG}_{i} \cdot \tilde{{s}^{′}} ) ← ( \frac{{G}_{i} b + {δ}_{i , 0}}{{P}^{′}} , \frac{{G}_{i} a + {δ}_{i , 1}}{{P}^{′}} )$$

Combining Corollary 2 and Theorem 3, two switching keys may be generated from one compact transmission key TrmKey. Specifically, the intermediate key IntSwk is first generated from TrmKey through Theorem 3, and then may be decomposed into two switching keys using Corollary 2. For example, when a client wants to transmit switching keys mulk and cjk for multiplication mulk and conjugation, it may be sufficient to transmit only one transmission key as follows.

$$TrmEvk = {Enc}_{s} ∼ ( {PP}^{′} \cdot ( {s ( X )}^{2} + Y \cdot s ( {X}^{- 1} ) ) )$$

This key is defined together with R′_{P′PQ} and may be transmitted to the server 200 together with the homing key hk. Then, the server 200 may generate the mulk and cjk through the following intermediate key.

$$IntEvk = {\{ {Enc}_{s} ∼ ( {PG}_{i} \cdot ( {s}^{2} ( X ) + Y \cdot s ( {X}^{- 1} ) ) ) \}}_{i ∈ ⌈ dnum ⌉} .$$

Note that, if P′≥max,{Q/Qᵢ}≃Q/Q^{1/dnum} is chosen, the following is established.

$${P}^{′} PQ ≃ {Q}^{2} < {Q}_{max , N}^{2} ≃ {Q}_{max , 2 N}$$

This ensures that the transmission key

$$TrmEvk ∈ {R}_{{P}^{′} PQ}^{′ 2}$$

does not exceed a security margin.
C. Rotation Key Generation over Extension Ring

A rotation key is one of the key-switching keys, which may be generally generated more efficiently than multiplication mulk or conjugation. As a simple approach, the above technique may be applied to reduce the communication cost of the rotation key transmission. However, the rotation keys are frequently required (e.g., more than 265 are required in [LLKN23] for ResNet-20 inference). In this case, the overall communication cost may still be unsatisfactory.

[LLKN23]proposed a notable solution to this problem by introducing a hierarchical key management system, but the approach still has limitations. In the FHE parameter setting, the ring degree of N=2¹⁶ is usually used. In this case, Q_{key} may be set to Q_{max,N}, which is close to the top ciphertext modulus Qₜₒₚ. This tight budget makes it difficult to apply multiple special moduli P⁽⁰⁾, . . . , P^{(k-1)}, and as a result, the hierarchy level may be limited to k=2.

In a two-level hierarchy, Q⁽²⁾=P⁽¹⁾Q_{key}=Q_{max,N} is set, and the gadget rank may increase to dnum⁽¹⁾=┌logQ_{key}/logP⁽¹⁾┐ (for small P⁽¹⁾). In addition, transmitting only a small number of master rotation keys may cause inefficient key generation on the server 200 side. In fact, [LLKN23]transmits 8 master rotation keys as a set of 16-ary indices, and even in this case, a key size of several gigabytes may still occur.

Hierarchical Key System with an Extension Ring

To overcome this limitation, the intermediate rotation keys are generated in the extension ring R′ instead of the subring R. This is different from the existing method of generating the intermediate rotation keys in R. This approach may take advantage of the larger modulus budget Q_{max,2N}, which allows roughly twice the bit-length of the existing R. This additional budget may enable a deeper hierarchy with a very small top gadget rank dₙᵤₘ, for example, dₙᵤₘ=1.

For example, if we want to generate a rotation key for some index set T₀ under modulus Q⁽¹⁾=PQ. In this case, assume that is smaller than Qmax,N, then the following is established.

$$log {Q}_{max , 2 N} \approx 2 log {Q}_{max , N} > log {Q}_{max , N} > log {Q}^{( 1 )} ,$$

Since the modulus budget is sufficiently margin, the deeper hierarchy may be fully used. In particular, a 3-level hierarchy may be constructed as follows:

$${Q}^{( 2 )} = {Q}_{max , N} and {Q}^{( 3 )} = {Q}_{max , 2 N} .$$

This may set the top gadget rank to dnum(2)=1², which allows each master rotation key to be very small. Compared to the 2-level structure, the following relationship may be established.

$$2 N \cdot {log}_{Qmax , 2 N} < {dnum}^{( 1 )} \cdot N \cdot {log}_{Qmax , N}$$

If dnum⁽¹⁾>4, the left and right sides of this equation may correspond to the master rotation key sizes in the 3-level system (R′ phase) and the 2-level system (R phase), respectively. Since dnum⁽¹⁾=┌logQ⁽¹⁾/logP⁽¹⁾┐ is usually larger than 4, a much smaller master rotation key size may be acquired according to the present disclosure.

In addition, this 3-level hierarchy structure allows the number of master rotation keys that the client needs to transmit to the server 200 to be reduced more than the 2-level hierarchy structure. For example, given a 2-level hierarchy system including a transmission key for an index set T₁, a 3-level hierarchy system that configures a transmission key for an index set T₂⊂T₁ may be considered. Then, the intermediate key is generated with an index at the T₁ level, and a rotation key generation procedure is performed in the same manner as the conventional method at level 1. In actual implementations, various index sets are designed and chosen to increase the key generation efficiency.

In the hierarchical rotation key system of the present disclosure, a set

$${\{ {rotk}_{r}^{′ ( 0 )} \}}_{r ∈ {T}_{0}}$$

of intermediate rotation keys may be generated as follows.

$${rotk}_{r}^{′ ( 0 )} = {\{ {Enc}_{s} ∼ ( {PG}_{i} \cdot \tilde{s} ( {Y}^{{5}^{′}} ) ) \}}_{i ∈ ⌈ dnum ⌉} ∈ {R}_{PQ}^{′2 \times dnum} ,$$

It operates as the rotation key on R′, which is similar to the way described in Theorem 1. According to Theorem 4 described below, the rotation key for To may be reconstructed exactly on R from this intermediate key.

### Theorem 4 (Intermediate Rotation Key Generation)

If s(X)∈R, \tilde{s}(Y)=s+Y \tilde{s}₁∈R′ is a secret key, and the homing key hk defined in Corollary 2 is given, then the rotation key for the same index r on R may be acquired by applying the ring switching to the rotation key for index r on the extension ring R′ using hk.

### Proof

$$b ( y ) + a ( y ) \cdot \tilde{s} ( Y ) = P {G}_{i} \cdot \tilde{s} ( {y}^{{5}^{r}} ) + e ( y ) ( mod PQ ) .$$

The following may acquired from \tilde{s}(Y)=s₀(Y²)+Y·\tilde{s}₁(Y²).

$$\tilde{s} ( {Y}^{{5}^{r}} ) = s ( {y}^{2 \cdot {5}^{r}} ) + {Y}^{{5}^{r}} \cdot {\tilde{s}}_{1} ( {y}^{2 \cdot {5}^{r}} ) = s ( {X}^{{5}^{r}} ) + Y \cdot ( {X}^{\frac{{5}^{r} - 1}{2}} {\tilde{s}}_{1} ( {X}^{{5}^{r}} ) ) .$$

In the same scheme as Theorem 1, if b(Y)=b₀+Yb₁, a(Y)=a₀+Ya₁, e(Y)e₀+Ye₁, then the following equation for X may be acquired.

$${b}_{0} + {a}_{0} s + ( X \cdot {a}_{1} ) \cdot \tilde{s} = {PG}_{i} \cdot s ( {X}^{{5}^{r}} ) + {e}_{0} ( mod P Q ) .$$

The following is established.

$${Enc}_{s} ( P {G}_{i} \cdot s ( {X}^{{5}^{r}} ) ) ← ( {b}_{0} , {a}_{0} ) + {KeySwitch}_{hk} ( 0 , {Xa}_{1} ) ,$$

This is an i-th ciphertext of the rotation key for index r, and is defined on R.

Hereinafter, the key management system is described in more detail.

### Key Management Systems

### A. KG+ Key Management System

In addition to the encryption key enck on R_{Q}, the server 200 requires evaluation keys such as a multiplication key mulk, a conjugate key cjk, and a rotation key {rotkᵣ}ᵣ∈T₀ on R_{PQ}. To make this possible, the client may generate two secret keys s, s′∈R and define an extended secret key \tilde{s}(Y)s+Y·s′∈R′ Then, KG+ constructs a k-level hierarchical rotation key system for R′, usually set to k=3, and the client may transmit the following transmission keys to the server 200.
Encryption key enck′=Encₛ˜(0) over R′_{Q}_{^{(k-1)}},
Transmission key on R′_{P′PQ}

$$TrmEvk = E n {c}_{\tilde{s}} ( {P}^{′} P ( {s}^{2} ( X ) + Ys ( {X}^{- 1} ) ) ,$$

m=|Tₖ₋₁| and, master rotation keys

$${\{ r o t {k}_{r}^{′ ( k - 1 )} \}}_{r ∈ T \text{?}} on {R}_{{Q}^{\text{?}}}^{′}$$

$$\text{?} \text{indicates text missing or illegible when filed}$$

Homming key hk←SwkGen(N, PQ, Q_{max,N}, s′, s). on R_{Q}_{_{max,N}}

Using Corollary 2, the server 200 may generate the encryption key enck from the received enck′ and hk. Combining Corollary 2 and Theorem 3, the server 200 may also generate the mulk and cjk from the received TrmEvk and hk. In addition, through the k-level hierarchy system, the server 200 may generate the intermediate rotation key

$${\{ r o t {k}_{r}^{′ ( 0 )} \}}_{r ∈ T 0}$$

for the required index set T₀ using the master rotation keys and enck′. The final rotation keys {rotkᵣ}_{r∈T0} may be acquired on R by applying Theorem 4. In particular, it is noted that the server 200 does not use R′ at all after the key generation, so it may not affect the latency of the homomorphic operation at all.

Each transmission key size is estimated as follows.

$${enck}^{′} : 2 N \cdot log {Q}^{( k - 1 )} ,$$

$$TrmEVK : 2 N \cdot log {P}^{′} PQ = 2 N \cdot 2 log Q ,$$

$$Master rotation keys : \vert {T}_{k - 1} \vert \cdot {dnum}^{( k - 1 )} \cdot 2 N \cdot log {Q}^{( k )} ,$$

$$hk : {dnum}^{( h )} \cdot N \cdot log {Q}_{max , N} .$$

Here, P≈Q^{1/dnum}, P≈Q/Q^{1/dnum}, and dnum^{(h)} is the gadget rank required for the key switching from modulus PQ to Q_{max,N}, which is defined as follows.

$${{dnum}^{( h )}}_{=} ⌈ \frac{log PQ}{log {Q}_{max , N} - log PQ} ⌉ .$$

Now, combining all the above factors, the entire transmission key size is estimated as follows.

$$( 2 log {Q}^{( k 1 )} + 4 log Q + m \cdot {dnum}^{( k - 1 )} \cdot 2 log {Q}^{( k )} + {dnum}^{( h )} log {Q}_{max , N} ) \cdot N .$$

### B. BTS+ Key Management System

KG+ effectively reduces the transmission key size, but the homing key hk, which still has a large size, is still unsatisfactory because it depends on R, requires a large gadget rank dnum^{(h)}, and also utilizes the already strict modulus budget. That is, the modulus PQ is already very close to Q_{max,N}.

To address this issue, the modified key management system, BTS+, allows the homing key size to be reduced as desired by the server 200, resulting in some degradation of computational efficiency.

To reduce the homing key size, small gadget rank dnum^{(h)} may be chosen in BTS+. Using such a small-sized homing key makes the key size of the ring-switching computation have a modulus smaller than Q_{comp}.

Then, all calculations after the bootstrapping are limited to the ciphertext with modulus Q_{comp}, and the bootstrapping procedures CoeffToSlot and EcalMod of the ciphertext with modulus Q>Q_{comp} are performed on the extension ring R′ instead of the ring R. Specifically, an additional modulus chain may be introduced on the ring R as follows.

$${Q}_{comp} < {Q}^{( h )} = {P}_{comp} {Q}_{comp} < {Q}_{max , N} = {P}^{( h )} {Q}^{( h )} .$$

Here, Q^{(h)} is a modulus to which the homing key is applied and is used as a new key-switching modulus on R. At this time, the gadget rank dnum^{(h)} of the corresponding key is given as follows.

$${dnum}^{( h )} = ⌈ \frac{log {Q}^{( h )}}{log {Q}_{max , N} - {logQ}^{( h )}} ⌉ .$$

In BTS+, dnum^{(h)} uses a parameter that satisfies 1 or 2. This may significantly reduce the homing key size compared to KG+. Importantly, the reduced dnum^{(h)} value does not affect the throughput of the homomorphic operation after the key generation. In general CKKS parameters (e.g., [BMTHP21], [BCC+24]), when the ring degree is less than 2¹⁷, the rotation key may also be generated with the homing key whose dnum^{(h)} is 1 or 2. This key is performed in Q^{(h)} and has very high key switching efficiency. Note that 2 is the optimal computational gadget coefficient for a fixed modulus [MG23]. The components for the homomorphic operation are performed in R′ and are highly parallelizable operations. The bootstrapping may also be designed to be performed in R′. The following is the transmission key configuration of the BTS+ system. The server 200 requires the following keys.
Encryption key enck′=Encₛ˜(0)
Transmission key on R′_{PPQ}

$$TrmMulk = E n {c}_{\tilde{s}} ( {P}^{′} P \cdot {s}^{- 2} ( Y ) ) , and$$

$$TrmCjk = En {c}_{\tilde{s}} ( {P}^{′} P \cdot \tilde{s} ( {Y}^{- 1} ) ) ,$$

Transmission key on R′_{P′}_{_{comp}}_{Q}_{^{(h)}}

$$TrmEvk = {Enc}_{s} \sim ( {P}_{comp}^{′} {P}_{comp} ( {s}^{2 ( X )} + Ys ( {X}^{- 1} ) ) ,$$

m=|Tₖ₋₁| and, master rotation keys

$${\{ {rotk}_{r}^{{′}^{( k - 1 )}} \}}_{r ∈ {T}_{\text{?}}} on {R}_{{Q}^{( k )}}^{′}$$

$$\text{?} \text{indicates text missing or illegible when filed}$$

Homing key hk←SwkGen(N,Q^{(h)}, Q_{max,N}, s′, s), on R_{Q}_{_{max,N}}
Leaving key lk←SwkGen(2N, q, qp, s, \tilde{s}), on R′_{pq}

The server 200 generates mulk′ and cjk′ on R′_{PQ} using Theorem 3 from TrmMulk and TrmCjk. Meanwhile, the evaluation key (evk) is generated from TrmEvk. The server 200 generates the rotation keys such as {rotkᵣ}_{r∈T}, {rotk′ᵣ}_{r∈T}, on both R and R′. The living key allows to switch the ciphertext in the base modulus q, thereby enabling the switching from R to R′. Here, p and q may be small prime numbers chosen to maintain gadget rank 1.

### Transmission Key Size

In BTS+, the size of each transmission key is described below. The following keys have been newly introduced or updated in the BTS+.”
TrmMulk, TrmCjk: 4N·logP′PQ≈4N·2logQ,
TrmEvk: 2N·logP′_{comp}·P_{comp}Q^{(h)}≤2N·logQ_{max,N},
hk: dnum^{(h)}·N·logQ_{max,N}≤2N·logQ_{max,N},
lk: 2N·logpq≈4N·logq.

The advantage of reducing the homing key size to dₙᵤₘ(h) value of 1 or 2 more than offsets the overhead caused by the added keys. Combining all of this, the entire transmission key size in the BTS+ system is estimated as follows.

$$( 2 log {Q}^{( k - 1 )} + 8 log Q + m \cdot {dnum}^{( k - 1 )} \cdot 2 log {Q}^{( k )} + 4 log q + 4 log {Q}_{max , N} ) \cdot N .$$

### Implementation

KG+ and [LLKN23] may be implemented using the HEaaN CKKS library [Cry22]. The client-side experiments were measured on an Intel Xeon gold 6542Y with a single-threaded CPU, and the server 200-side experiments were performed on an NVIDIAA100 80 GB PCIe GPU.

### A. Parameter Settings

For a fair comparison with [LLKN23], the same ring was used and the same evaluation keys were generated. The details are presented in Table III and Table IV (A.i, A.ii, A.iii). The parameter set of [LLKN23] using ring degree 2¹⁶ was adopted. This is a common choice in most implementations. All parameters satisfy 128-bit security level according to [LLKN23], [MML+23].

TABLE 2

| | Ring R | Ext. ring R′ |
|---|---|---|
| ring degree N | 2¹⁶ | 2¹⁷ |
| secret key hamming weight h | 2¹⁵ | 2¹⁶ |
| SD of gaussian error σ | 3.2 | 3.2 |
| logQₘₐₓ | 1714 | 3428 |

### CKKS Parameters (Ring R and Extension Ring R′)

For each parameter in set A, B and E parameter sets were used together for implementing the 2-level hierarchical system of [LLKN23] and KG+. For the 3-level system, C and D parameter sets were used. In addition, the ring R is used for evaluation key generation in parameters C and D, and the extension ring R′ is used for the bootstrapping.

For [LLKN23], the B-parameter set was used. For the rotation key transmission for ResNet-20 inference, the rotation keys corresponding to hexadecimal indices such as {±1,±16,±162,±163} were transmitted (including positive and negative numbers). In the bootstrapping experiment, the rotation keys corresponding to base-32 index {±1,±2⁵,±2¹⁰} were transmitted.

TABLE 3

| | | |
|---|---|---|
| Parameters | dnum | Modulus bit length |

| | | | |
|---|---|---|---|
| Original | A.i | 4 | (1321, 333) |
| (1-level) | A.ii | 5 | (1321, 273) |
| | A.iii | 6 | (1321, 221) |
| [LLKN23] | B.i | (4, 30) | (1321, 333, 59) |
| (2-level) | B.ii | (5, 15) | (1321, 273, 118) |
| | B.iii | (6, 10) | (1321, 221, 171) |
| KG+ | C.i | (4, 30, 1) | (1321, 333, 59, 1715) |
| (3-level) | C.ii | (5, 15, 1) | (1321, 273, 118, 1715) |
| | C.iii | (6, 10, 1) | (1321, 221, 171, 1715) |
| KG+ | D.i | (4, 3, 2) | (1321, 333, 560, 1140) |
| (3-level) | D.ii | (5, 3, 2) | (1321, 273, 560, 1140) |
| | D.iii | (6, 3, 2) | (1321, 221, 560, 1083) |
| KG+ | E.i | (4, 1) | (1321, 333, 1668) |
| (2-level) | E.ii | (5, 1) | (1321, 273, 1660) |
| | E.iii | (6, 1) | (1321, 221, 1578) |

### Parameter Set

For KG+, the evaluation key is generated using the B-parameter set. In this case, the transmission key is configured using the C, D, and E parameter sets. In particular, after completing the hierarchical key generation using the C, D, and E parameter sets in R′, the parameters of each intermediate rotation key rotkᵣ are converted to the B-parameter set using the homing key. The key switched in this way becomes the desired rotation key rotkᵣ′ on R.

When using the C parameter set, only two master rotation keys corresponding to rotation indices {1,28} are transmitted to minimize the size of the master rotation key. In the key generation process, the 1-level rotation key is generated from the 4-ary index set {1, 2², 2⁴, 2⁶, 2⁸, 2¹⁰, 2¹², 2¹⁴}. Finally, a 0-level rotation key is generated from the 1-level 4-ary rotation key. This parameter is effective in reducing the client-side cost along with the appropriate key generation time.

For the D parameter set, it is configured almost the same as the C parameter set, but in order to further accelerate the key generation on the server 200 side, the dₙᵤₘ value of the master rotation key is set to 2(dₙᵤₘ⁽²⁾), and the remaining dₙᵤₘ values are adjusted accordingly.

Finally, for the E parameter set, a 2-level KG+ using three master rotation keys is applied. This scheme provides a more efficient key generation process and is particularly suitable for setting the FHE parameters, which require only a small number of rotation keys for the bootstrapping. In the E parameter, the master rotation key index may be chosen as {1, 2⁵, 2¹⁰}.

### B. Key Generation for ResNet-20 Models

Experimental results of [LLKN23] and KG+ are presented, which include the generation of 265 rotation keys required for ResNet-20 inference on the CIFAR-10 dataset.

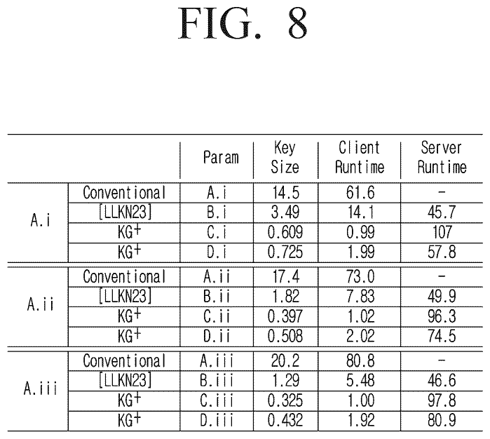

Referring to the exact index set required for ResNet-20 inference proposed by [LLKN23], the rotation key is located on the ring R with the number of slots n=2¹⁵. The experimental results for all settings are illustrated in FIG. 8.

The C parameter set of KG+ is illustrated to reduce the key size by about 3.95 to 5.73 times and the client-side execution time by about 5.48 to 14.25 times compared to [LLKN23]. However, the server 200-side execution time increases by about 1.95 to 2.35 times.

The D parameter set increases the key size and the client-side execution time compared to C, but reduces the server 200-side execution time by 1.26 to 1.74 times.

All the KG+ experimental results show a significant improvement in the client-side cost. In addition, the settings such as log q=60 and dₙᵤₘ(h)=2 are used for the A parameter set for ResNet-20 in BTS+ estimation. The transmission key recommendation is as follows.

TABLE 4

| Parameters | [LLKN23] | BTS+ (C param) | |
|---|---|---|---|
| A.i | 3.49 | 0.285 | (12.25 × ↓) |
| A.ii | 1.82 | 0.285 | (6.39 × ↓) |
| A.iii | 1.29 | 0.285 | (4.53 × ↓) |

### Transmission Key Size

### C. Key Generation for Bootstrapping

Experimental results for generating evaluation keys for reasonable bootstrapping are presented in the CKKS scheme. This experiment assumes a ring degree of 2¹⁶. Assume the server 200 uses the multiplication key, the conjugation key, and 38 rotation keys during the bootstrapping process. This configuration is a common FHE parameter configuration used in many CKKS libraries, including [Cry22] and [lat24].

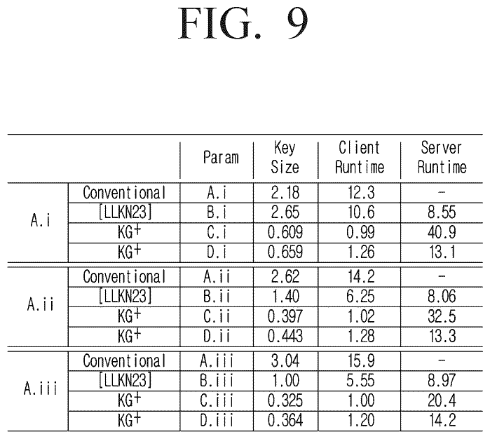

The experimental results are illustrated in FIG. 9. [LLKN23] did not significantly reduce the key size or client runtime in this setting. This is because in this setting, where the server 200 uses relatively few rotation keys, the size of one master rotation key is larger than each evaluation key, so that [LLKN23] sometimes comes out larger than the size of 38 evaluation keys in terms of the total key size. In particular, this phenomenon occurs in the A.i parameter set.

On the other hand, KG+(C parameter set) reduced the key size by 3.09 to 4.37 times and the client runtime by 5.55 to 10.65 times, and the server 200 runtime increased by 2.28 to 4.78 times. The E parameter set slightly increases the key size and client execution time compared to C, but reduces the server 200 execution time by 1.53× to 1.58×. All the KG+ experimental results show that the client-side cost is significantly improved over [LLKN23].

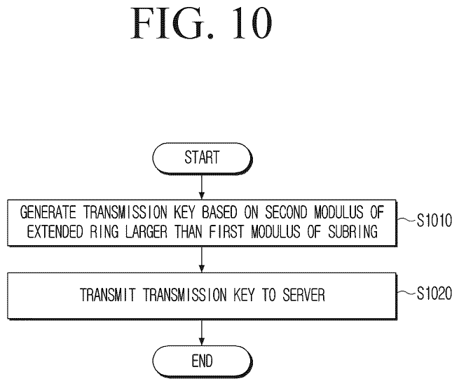

FIG. 10 is a flowchart for describing a control method of an electronic apparatus according to an embodiment of the present disclosure.

First, the transmission key is generated based on the second modulus of the extension ring that is larger than a first modulus of a subring (S1010). Then, the transmission key is transmitted to the server (S1020).

In addition, in the generating of the transmission key (S1010), a plurality of secret polynomials may be generated, the combined polynomial of the extension ring may be acquired based on the plurality of secret polynomials, a plaintext polynomial may be acquired based on the combined polynomial and the third modulus for key switching, and the plaintext polynomial may be encrypted on the extension ring to generate the transmission key.

In the generating of the transmission key (S1010), the transmission key in the form of one ciphertext including the third modulus for the key switching may be generated based on the second modulus and the second gadget rank of the extension ring smaller than the first gadget rank of the subring, and the transmission key may include a value obtained by multiplying the target secret key by the preset coefficient.

In addition, the method further includes acquiring the key switching key for the partial polynomial based on the partial polynomial of the secret key of the subring and the target secret key of the extension ring as the homing key, and in the transmitting step (S1010), the homing key and the transmission key may be transmitted to the server.

In the acquiring, the preset term of the secret key may be input to the special key generation function configured based on the gadget decomposition used in the key switching to generate the homing key.

In addition, the homing key may be the key of the subring.

The transmission key may be switched to the computation key of the subring through the ring switching based on the homing key by the server, and the transmission key may have a smaller capacity than the computation key.

In addition, the transmission key is switched to the intermediate key by the server based on the second modulus and the second gadget rank of the extension ring, which is smaller than the first gadget rank of the subring, and the intermediate key may be switched to the computation key of the subring through the ring switching.

The intermediate key may include at least one coefficient of a value included in the fixed-size gadget vector.

### REFERENCES

[ABBB+22] Ahmad A I Badawi, Jack Bates, Flavio Bergamaschi, David Bruce Cousins, Saroja Erabelli, Nicholas Genise, Shai Halevi, Hamish Hunt, Andrey Kim, Yongwoo Lee, Zeyu Liu, Daniele Micciancio, Ian Quah, Yuriy Polyakov, Saraswathy R. V., Kurt Rohloff, Jonathan Saylor, Dmitriy Suponitsky, Matthew Triplett, Vinod Vaikuntanathan, and Vincent Zucca. Openfhe: Opensource fully homomorphic encryption library. In Proceedings of the 10th Workshop on Encrypted Computing & Applied Homomorphic Cryptography, WAHC'22, pages 53-63, New York, NY, USA, 2022. Association for Computing Machinery.
[BCC+24] Jean-Philippe Bossuat, Rosario Cammarota, Ilaria Chillotti, Benjamin R Curtis, Wei Dai, Huijing Gong, Erin Hales, Duhyeong Kim, Bryan Kumara, Changmin Lee, et a1. Security guidelines for implementing homomorphic
encryption. Cryptology ePrint Archive, 2024.
[BCK+23]Y Bae, J. H. Cheon, J. Kim, J. H. Park, and D. Stehl'e. HERMES: efficient ring packing using MLWE ciphertexts and application to transciphering. In CRYPTO, 2023.
[BCKS24] Youngjin Bae, Jung Hee Cheon, Jaehyung Kim, and Damien Stehl'e. Bootstrapping bits with ckks. In Annual International Conference on the Theory and Applications of Cryptographic Techniques, pages 94-123. Springer, 2024.
[BGV14] Zvika Brakerski, Craig Gentry, and Vinod Vaikuntanathan. (leveled) fully homomorphic encryption without bootstrapping. ACM Transactions on Computation Theory (TOCT), 6(3):1-36, 2014.
[BMTPH21] Jean-Philippe Bossuat, Christian Mouchet, Juan Troncoso-Pastoriza, and Jean-Pierre Hubaux. Efficient bootstrapping for approximate homomorphic encryption with non-sparse keys. In EUROCRYPT, pages 587-617. Springer, 2021.
[Bra12]Z. Brakerski. Fully homomorphic encryption without modulus switching from classical gapSVP. In CRYPTO, 2012.
[CGGI17]I. Chillotti, N. Gama, M. Georgieva, and M. Izabach'ene. Faster packed homomorphic computations and efficient circuit bootstrapping for TFHE. In ASIACRYPT, 2017.
[CKKS17] Jung Hee Cheon, Andrey Kim, Miran Kim, and Yongsoo Song. Homomorphic encryption for arithmetic of approximate numbers. In ASIACRYPT, pages 409-437. Springer, 2017.
[CP19] Benjamin R Curtis and Rachel Player. On the feasibility and impact of standardising sparse-secret lwe parameter sets for homomorphic encryption. In Proceedings of the 7th ACM Workshop on Encrypted Computing & Applied Homomorphic Cryptography, pages 1-10, 2019.
[Cry22] CryptoLab. HEaaN library, 2022. Is available at https://heaan.it/.
[DM15]L. Ducas and D. Micciancio. FHEW: bootstrapping homomorphic encryption in less than a second. In EUROCRYPT, 2015.
[FV12]J. Fan and F. Vercauteren. Somewhat practical fully homomorphic encryption, 2012. Available at http://eprint.iacr.org/2012/144.
[GHPS13] Craig Gentry, Shai Halevi, Chris Peikert, and Nigel P Smart. Field switching in bgv-style homomorphic encryption. Journal of Computer Security, 21(5):663-684, 2013.
[HK20] Kyoohyung Han and Dohyeong Ki. Better bootstrapping for approximate homomorphic encryption. In Cryptographers' Track at the RSA Conference, pages 364-390. Springer, 2020.
[HKL+22] Jincheol Ha, Seongkwang Kim, ByeongHak Lee, Jooyoung Lee, and Mincheol Son. Rubato: Noisy ciphers for approximate homomorphic encryption. In EUROCRYPT, pages 581-610. Springer, 2022.
[lat24] Lattigo v6. Online: https://github.com/tuneinsight/lattigo, August 2024. EPFL-LDS, Tune Insight S A.
[LLKN23] Joon-Woo Lee, Eunsang Lee, Young-Sik Kim, and Jong-Seon No. Rotation key reduction for client-server systems of deep neural network on fully homomorphic encryption. In ASIACRYPT, pages 36-68. Springer, 2023.
[LLL+22] Eunsang Lee, Joon-Woo Lee, Junghyun Lee, Young-Sik Kim, Yongjune Kim, Jong-Seon No, and Woosuk Choi. Low-complexity deep convolutional neural networks on fully homomorphic encryption using multiplexed parallel convolutions. In International Conference on Machine Learning, pages 12403-12422. PMLR, 2022.
[LPR10]V. Lyubashevsky, C. Peikert, and O. Regev. On ideal lattices and learning with errors over rings. In EUROCRYPT, 2010.
[MG23] Johannes Mono and Tim G*uneysu. A new perspective on key switching for bgv-like schemes. Cryptology ePrint Archive, 2023.
[MML+23] Johannes Mono, Chiara Marcolla, Georg Land, Tim G*uneysu, and Najwa Aaraj. Finding and evaluating parameters for bgv. In International Conference on Cryptology in Africa, pages 370-394. Springer, 2023.
[SSTX09]D. Stehl'e, R. Steinfeld, K. Tanaka, and K. Xagawa. Efficient public key encryption based on ideal lattices. In ASIACRYPT, 2009.

As described above, since the electronic apparatus transmits the transmission key to the server and the server may generate the plurality of evaluation keys from the transmission key, the transmission efficiency may be improved compared to the conventional case where the ciphertext is transmitted for each computation key.

Meanwhile, according to an embodiment of the disclosure, various embodiments described above may be implemented by software including instructions stored in a machine-readable storage medium (for example, a computer-readable storage medium). A machine may be an apparatus that invokes the stored instruction from the storage medium and may be operated depending on the invoked instruction, and may include the electronic apparatus (for example, the electronic apparatus A) according to the disclosed embodiments. In the case in which a command is executed by the processor, the processor may directly perform a function corresponding to the command or other components may perform the function corresponding to the command under a control of the processor. The command may include codes created or executed by a compiler or an interpreter. The machine-readable storage medium may be provided in a form of a non-transitory storage medium. Here, the term “non-transitory” means that the storage medium is tangible without including a signal, and does not distinguish whether data are semi-permanently or temporarily stored in the storage medium.

In addition, according to an embodiment of the disclosure, the above-described methods according to the diverse embodiments may be included and provided in a computer program product. The computer program product may be traded as a product between a seller and a purchaser. The computer program product may be distributed in a form of a storage medium (for example, a compact disc read only memory (CD-ROM)) that may be read by the machine or online through an application store (for example, PlayStore™). In case of the online distribution, at least a portion of the computer program product may be at least temporarily stored in a storage medium such as a memory of a server of a manufacturer, a server of an application store, or a relay server or be temporarily generated.

In addition, according to an embodiment of the disclosure, the diverse embodiments described above may be implemented in a computer or a computer-readable recording medium using software, hardware, or a combination of software and hardware. In some cases, embodiments described in the present disclosure may be implemented by the processor itself. According to a software implementation, embodiments such as procedures and functions described in the disclosure may be implemented by separate software. Each software may perform one or more functions and computations described in the disclosure.

Meanwhile, computer instructions for performing processing computations of the machines according to the diverse embodiment of the disclosure described above may be stored in a non-transitory computer-readable medium. The computer instructions stored in the non-transitory computer-readable medium allow a specific machine to perform the processing computations in the machine according to the diverse embodiments described above when they are executed by a processor of the specific machine. The non-transitory computer-readable medium is not a medium that stores data for a while, such as a register, a cache, a memory, or the like, but means a medium that semi-permanently stores data and is readable by the apparatus. A specific example of the non-transitory computer-readable medium may include a compact disk (CD), a digital versatile disk (DVD), a hard disk, a Blu-ray disk, a universal serial bus (USB), a memory card, a read only memory (ROM), or the like.

In addition, each of components (for example, modules or programs) according to various embodiments described above may include a single entity or a plurality of entities, and some of the corresponding sub-components described above may be omitted or other sub-components may be further included in the diverse embodiments. Alternatively or additionally, some components (e.g., modules or programs) may be integrated into one entity and perform the same or similar functions performed by each corresponding component prior to integration. Computations performed by the modules, the programs, or the other components according to the diverse embodiments may be executed in a sequential manner, a parallel manner, an iterative manner, or a heuristic manner, at least some of the computations may be performed in a different order or be omitted, or other computations may be added.

Although embodiments of the disclosure have been illustrated and described hereinabove, the disclosure is not limited to the abovementioned specific embodiments, but may be variously modified by those skilled in the art to which the disclosure pertains without departing from the gist of the disclosure as disclosed in the accompanying claims. These modifications should also be understood to fall within the scope and spirit of the disclosure.

1. An electronic apparatus, comprising:
a memory storing instructions;
a communication interface; and
at least one processor configured to include a processing circuitry,
wherein the at least one processor
is configured to generate a transmission key based on a second modulus of an extended ring that is larger than a first modulus of a subring, and
control the communication interface to transmit the transmission key to a server.

2. The electronic apparatus as claimed in claim 1, wherein the at least one processor is configured to generate a plurality of secret polynomials,
acquire a combined polynomial of the extended ring based on the plurality of secret polynomials,
acquire a plaintext polynomial based on the combined polynomial and a third modulus for key switching, and
encrypt the plaintext polynomial on the extended ring to generate the transmission key.

3. The electronic apparatus as claimed in claim 1, wherein the at least one processor is configured to generate the transmission key in a form of one ciphertext including a third modulus for key switching based on the second modulus and a second gadget rank of the extended ring that is smaller than a first gadget rank of the subring, and
the transmission key includes a value obtained by multiplying a target secret key by a preset coefficient.

4. The electronic apparatus as claimed in claim 1, wherein the at least one processor is configured to acquire, as a homing key, a key switching key for a partial polynomial based on the partial polynomial of a secret key of the subring and a target secret key of the extended ring, and
control the communication interface to transmit the homing key and the transmission key to the server.

5. The electronic apparatus as claimed in claim 4, wherein the at least one processor is configured to generate the homing key by inputting a preset term of the secret key to a special key generation function configured based on gadget decomposition used in key switching.

6. The electronic apparatus as claimed in claim 4, wherein the homing key is a key of the subring.

7. The electronic apparatus as claimed in claim 1, wherein the transmission key is switched into an computation key of the subring through ring switching based on a homing key by the server, and
the transmission key has a smaller capacity than the computation key.

8. The electronic apparatus as claimed in claim 7, wherein the transmission key is switched into an intermediate key by the server based on the second modulus and a second gadget rank of the extended ring that is smaller than a first gadget rank of the subring, and
the intermediate key is switched into an computation key of the subring through the ring switching.

9. The electronic apparatus as claimed in claim 8, wherein the intermediate key includes at least one coefficient of a value included in a fixed-size gadget vector.

10. A control method of an electronic apparatus, comprising:
generating a transmission key based on a second modulus of an extended ring that is larger than a first modulus of a subring, and
transmitting the transmission key to a server.

11. The control method as claimed in claim 10, wherein the generating of the transmission key includes:
generating a plurality of secret polynomials;
acquiring a combined polynomial of the extended ring based on the plurality of secret polynomials;
acquiring a plaintext polynomial based on the combined polynomial and a third modulus for key switching; and
encrypting the plaintext polynomial on the extended ring to generate the transmission key.

12. The control method as claimed in claim 10, wherein the generating of the transmission key includes:
generating the transmission key in a form of one ciphertext including a third modulus for key switching based on the second modulus and a second gadget rank of the extended ring that is smaller than a first gadget rank of the subring, and
the transmission key includes a value obtained by multiplying a target secret key by a preset coefficient.

13. The control method as claimed in claim 10, further comprising:
acquiring, as a homing key, a key switching key for a partial polynomial based on the partial polynomial of a secret key of the subring and a target secret key of the extended ring,
wherein the transmitting includes transmitting the homing key and the transmission key to the server.

14. The control method as claimed in claim 13, wherein the acquiring includes generating the homing key by inputting a preset term of the secret key to a special key generation function configured based on gadget decomposition used in key switching.

15. The control method as claimed in claim 13, wherein the homing key is a key of the subring.

16. The control method as claimed in claim 10, wherein the transmission key is switched into an computation key of the subring by the server through ring switching based on a homing key, and
the transmission key has a smaller capacity than the computation key.

17. The control method as claimed in claim 16, wherein the transmission key is switched into an intermediate key by the server based on the second modulus and a second gadget rank of the extended ring that is smaller than a first gadget rank of the subring, and
the intermediate key is switched into an computation key of the subring through the ring switching.

18. The control method as claimed in claim 17, wherein the intermediate key includes at least one coefficient of a value included in a fixed-size gadget vector.
